(19) United States
(12) Patent Application Publication
(10) Pub. No.: US 2026/0341974 A1
(43) Pub. Date: Oct. 29, 2026

(54) ANTENNA ELEMENT, ANTENNA ARRAY, AND ANTENNA MODULE

(71) Applicant: Sony Semiconductor Solutions Corporation, Kanagawa (JP)

(72) Inventors: Satoru Tsuboi, Kanagawa (JP); Yoshitaka Yoshino, Tokyo (JP); Takatoshi Tsuji, Tokyo (JP); Tadashi Imai

(21) Appl. No.: 19/491,177

(22) PCT Filed: Jun. 19, 2024
(86) PCT No.: PCT/JP2024/022207

§ 371 Date: Dec. 8, 2025

(30) Foreign Application Priority Data
Jun. 28, 2023 (JP) 2023-105712

(51) Int. Cl. H01Q 21/06; H01Q 1/24; H01Q 1/52; H01Q 9/04

(52) U.S. Cl. CPC H01Q 21/065; H01Q 1/24; H01Q 1/526; H01Q 9/0414

(57) ABSTRACT

An antenna element, antenna array, and antenna module with miniaturization, wide bandwidth and a simplified structure are disclosed. In one example, an antenna element includes a first conductor layer having a planar element shape, a second conductor layer, a dielectric layer, a first interlayer connection portion, and a second interlayer connection portion. The second conductor layer is connected to a ground potential. The dielectric layer is provided between the first conductor layer and the second conductor layer. The first interlayer connection portion penetrates the dielectric layer and connects the first conductor layer to a power feed portion. The second interlayer connection portion penetrates the dielectric layer and connects the first conductor layer and the second conductor layer.

### TECHNICAL FIELD

The present technology relates to an antenna element, an antenna array, and an antenna module that are capable of transmitting or receiving electromagnetic waves of a millimeter wave, for example.

### BACKGROUND ART

In antennas used in a high frequency range, miniaturization of elements is enabled due to a short wavelength, and thus pattern antennas formed of a conductive material on an electronic substrate are generally used. In particular, recently, in small-sized antennas in a millimeter-wave range used for cellular or radar applications, there has been a demand for an antenna structure being more inexpensive and smaller-sized, having high gain and further having high directivity in a wide bandwidth in a limited space. As an antenna structure that has high mass productivity and has been most widely used as a directional antenna, a patch antenna serving as a planar antenna is widely known (see, e.g., Patent Literature 1).

### CITATION LIST

### Patent Literature

Patent Literature 1: Japanese Patent Application Laid-open No. 2022-51890

### DISCLOSURE OF INVENTION

### Technical Problem

However, in the patch antenna, a fractional bandwidth that can be covered by a single element is approximately several percentages. Providing a wider bandwidth needs a more complicated structure such as an array of a plurality of elements or a resonant structure of elements disposed across laminates, which limits the space and cost.

In view of the circumstances as described above, it is an object of the present technology to provide an antenna element, an antenna array, and an antenna module that are capable of achieving miniaturization and a wider bandwidth with a simple structure.

### Solution to Problem

An antenna element according to an embodiment of the present technology includes a first conductor layer having a planar element shape, a second conductor layer, a dielectric layer, a first interlayer connection portion, and a second interlayer connection portion.

The second conductor layer is connected to a ground potential.

The dielectric layer is provided between the first conductor layer and the second conductor layer.

The first interlayer connection portion penetrates the dielectric layer and connects the first conductor layer to a power feed portion.

The second interlayer connection portion penetrates the dielectric layer and connects the first conductor layer and the second conductor layer.

In the antenna element, the first conductor layer functions as a radiation element and the second conductor layer functions as a ground conductor plate, and the first interlayer connection portion, the first conductor layer, and the second interlayer connection portion form a loop antenna. This makes it possible to achieve miniaturization and a wider bandwidth with a simple structure.

The first conductor layer is typically formed to have a smaller area than an area of the second conductor layer. This makes it possible to achieve stable resonance in a target frequency band.

A loop length formed by the first interlayer connection portion, the first conductor layer, and the second interlayer connection portion may be equal to or smaller than one wavelength of a radio wave used, for example, may be a size corresponding to half a wavelength of the radio wave used. This makes it possible to achieve further miniaturization of the antenna element.

The planar shape of the first conductor layer may be a rectangular shape having a long side and a short side.

The first conductor layer may include a first region to which the first interlayer connection portion is connected, and a second region to which the second interlayer connection portion is connected, and the first region and the second region may be disposed away from a circumferential portion of the first conductor layer. This makes it possible to widen the directivity of radio waves.

The first region and the second region may be disposed in a direction parallel to the long side or in a direction intersecting with a direction parallel to the long side.

The dielectric layer may be a dielectric substrate made of a dielectric material, the first conductor layer may be a metal layer formed on a first main surface of the dielectric substrate, and the second conductor layer may be a metal layer formed on a second main surface of the dielectric substrate on a side opposite to the first main surface.

The second conductor layer may have an opening formed with an opening diameter larger than the first interlayer connection portion. This makes it possible to simplify an electrically insulating structure between the first interlayer connection portion and the second conductor layer.

The first interlayer connection portion and the second interlayer connection portion may be each a through-hole plating or an embedded via that is provided to the dielectric layer.

An antenna array according to an embodiment of the present technology includes a plurality of antenna elements.

Each of the plurality of antenna elements includes a first conductor layer having a planar element shape, a second conductor layer connected to a ground potential, a dielectric layer provided between the first conductor layer and the second conductor layer, a first interlayer connection portion that penetrates the dielectric layer and connects the first conductor layer to a power feed portion, and a second interlayer connection portion that penetrates the dielectric layer and connects the first conductor layer and the second conductor layer.

The first conductor layer of each of the plurality of antenna elements is arrayed on one surface of the dielectric layer.

At least one of the plurality of antenna elements may be a transmission antenna element, and at least another one of the plurality of antenna elements may be a reception antenna element.

The plurality of antenna elements may be arrayed in a matrix along a first axial direction and a second axial direction orthogonal to each other on the surface.

The first conductor layer may have a rectangular planar shape having a long side parallel to the first axial direction and a short side parallel to the second axial direction, and the short sides facing each other of two of the first conductor layers arrayed in the first axial direction may each have a notch that partially widens an interval between the two first conductor layers.

The second conductor layer of each of the plurality of antenna elements may be formed of a common conductor layer.

An antenna module according to an embodiment of the present technology includes a plurality of antenna elements and a signal processing circuit.

Each of the plurality of antenna elements includes a first conductor layer having a planar element shape, a second conductor layer connected to a ground potential, a dielectric layer provided between the first conductor layer and the second conductor layer, a first interlayer connection portion that penetrates the dielectric layer and connects the first conductor layer to a power feed portion, and a second interlayer connection portion that penetrates the dielectric layer and connects the first conductor layer and the second conductor layer.

The signal processing circuit is connected to the plurality of antenna elements.

### BRIEF DESCRIPTION OF DRAWINGS

FIG. 1 is a transparent perspective view of an antenna element according to a first embodiment of the present technology.

FIG. 2 is a cross-sectional side view of the antenna element.

FIG. 3 is a simulation result showing an example of a voltage standing wave ratio of the antenna element.

FIG. 4 is a simulation result showing radiation characteristics of the antenna element in an azimuth plane in 60 GHz.

FIG. 5 is a simulation result showing radiation characteristics of the antenna element in an elevation plane in 60 GHz.

FIG. 6 is a transparent perspective view of an antenna element according to Comparative example 1.

FIG. 7 is a cross-sectional side view of the antenna element according to Comparative example 1.

FIG. 8 is a simulation result showing an example of a voltage standing wave ratio of the antenna element according to Comparative example 1.

FIG. 9 is a simulation result showing radiation characteristics of the antenna element according to Comparative example 1 in an azimuth plane in 60 GHz.

FIG. 10 is a simulation result showing radiation characteristics of the antenna element according to Comparative example 1 in an elevation plane in 60 GHz.

FIG. 11 is a transparent perspective view of an antenna element according to Comparative example 2.

FIG. 12 is a side view of the antenna element according to Comparative example 2.

FIG. 13 is a simulation result showing an example of a voltage standing wave ratio of the antenna element according to Comparative example 2.

FIG. 14 is a simulation result showing radiation characteristics of the antenna element according to Comparative example 2 in an azimuth plane in 60 GHz.

FIG. 15 is a simulation result showing radiation characteristics of the antenna element according to Comparative example 2 in an elevation plane in 60 GHz.

FIG. 16 is a simulation result of comparing the antenna characteristics and the directivity of the antenna element shown in FIG. 1 and the antenna element of Comparative example 1 shown in FIG. 6.

FIG. 17 is a transparent perspective view of an antenna module according to a second embodiment of the present technology.

FIG. 18 is a plan view of the antenna module.

FIG. 19 is a block diagram showing a circuit configuration of the antenna module.

FIG. 20 is a perspective view, similar to FIG. 17, showing a configuration of an antenna module that is not subjected to isolation processing.

FIG. 21 is a simulation result showing isolation characteristics of one reception antenna with respect to a transmission antenna in the antenna module.

FIG. 22 is a simulation result showing isolation characteristics of another reception antenna with respect to the transmission antenna in the antenna module.

FIG. 23 is a simulation result showing isolation characteristics of still another reception antenna with respect to the transmission antenna in the antenna module.

FIG. 24 is a simulation result showing an example of isolation characteristics between reception antennas in the antenna module.

FIG. 25 is a simulation result showing another example of isolation characteristics between reception antennas in the antenna module.

FIG. 26 is a simulation result showing still another example of isolation characteristics between reception antennas in the antenna module.

FIG. 27 is a view for describing another configuration example of the isolation processing.

FIG. 28 is a perspective view showing another configuration example of the antenna element shown in FIG. 1.

FIG. 29 shows simulation results showing voltage standing wave ratio (VSWR) characteristics of the antenna element shown in FIG. 28 and radiation characteristics in an azimuth plane and an elevation plane in 60 GHz.

FIG. 30 is a perspective view showing another configuration example of the antenna element shown in FIG. 1.

FIG. 31 shows simulation results showing voltage standing wave ratio (VSWR) characteristics of the antenna element shown in FIG. 30 and radiation characteristics in an azimuth plane and an elevation plane in 60 GHz.

FIG. 32 is a perspective view showing another configuration example of the antenna element shown in FIG. 1.

FIG. 33 shows simulation results showing voltage standing wave ratio (VSWR) characteristics of the antenna element shown in FIG. 32 and radiation characteristics in an azimuth plane and an elevation plane in 60 GHz.

FIG. 34 is a perspective view showing another configuration example of the antenna element shown in FIG. 1.

FIG. 35 shows simulation results showing voltage standing wave ratio (VSWR) characteristics of the antenna element shown in FIG. 34 and radiation characteristics in an azimuth plane and an elevation plane in 60 GHz.

FIG. 36 is a perspective view showing another configuration example of the antenna element shown in FIG. 1.

FIG. 37 shows simulation results showing voltage standing wave ratio (VSWR) characteristics of the antenna element shown in FIG. 36 and radiation characteristics in an azimuth plane and an elevation plane in 60 GHz.

FIG. 38 is a perspective view showing another configuration example of the antenna element shown in FIG. 1.

FIG. 39 shows simulation results showing voltage standing wave ratio (VSWR) characteristics of the antenna element shown in FIG. 38 and radiation characteristics in an azimuth plane and an elevation plane in 60 GHz.

FIG. 40 is a view showing an example of an antenna module corresponding to the second embodiment.

FIG. 41 is a diagram showing isolation characteristics of the antenna module shown in FIG. 40.

FIG. 42 is a transparent perspective view of an antenna module according to a fourth embodiment.

FIG. 43 is a plan view of the antenna module according to the fourth embodiment.

FIG. 44 is a diagram showing isolation characteristics of the antenna module according to the fourth embodiment.

FIG. 45 is a transparent perspective view of an antenna module according to a modified example of the fourth embodiment.

FIG. 46 is a diagram showing isolation characteristics of the antenna module according to the modified example of the fourth embodiment.

### MODE(S) FOR CARRYING OUT THE INVENTION

Hereinafter, embodiments according to the present technology will be described with reference to the drawings.

### First Embodiment

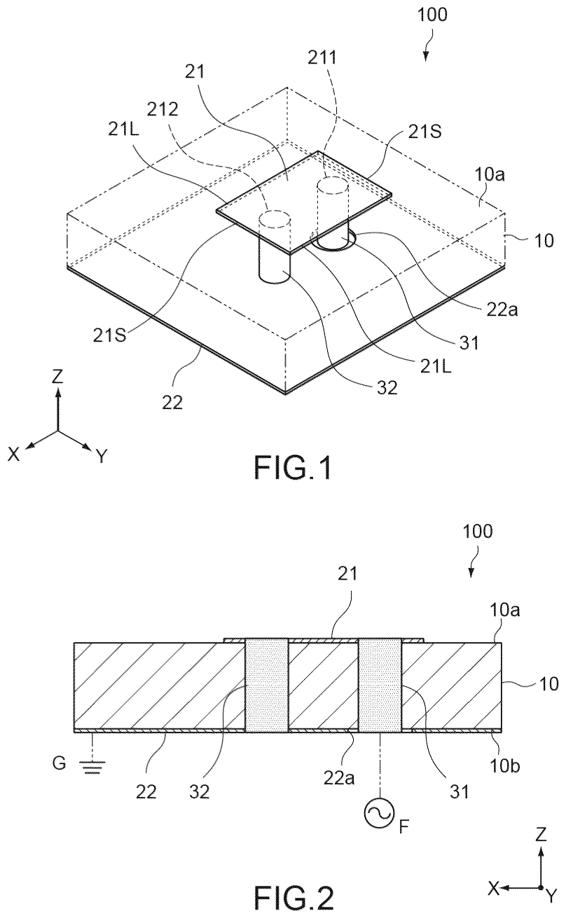

FIG. 1 is a transparent perspective view of an antenna element 100 according to a first embodiment of the present technology, and FIG. 2 is a cross-sectional side view of the antenna element 100. Note that in each figure, an X axis, a Y axis, and a Z axis indicate three axial directions orthogonal to one another, and respectively correspond to a longitudinal direction (front-rear direction), a lateral direction (width direction), and a thickness direction (height direction) of the antenna element 100.

### Basic Configuration of Antenna Element

The antenna element 100 of this embodiment is configured as a transmission, reception, or transmission/reception millimeter wave antenna. The antenna element 100 the antenna element 100 includes a dielectric layer 10, a first conductor layer 21, a second conductor layer 22, a first interlayer connection portion 31, and a second interlayer connection portion 32. The antenna element 100 is formed of a dielectric multilayer substrate (double-sided wiring substrate).

The dielectric layer 10 is provided between the first conductor layer 21 and the second conductor layer 22. The dielectric layer 10 is a dielectric substrate having rigidity and corresponds to an insulating layer that constitutes the dielectric multilayer substrate. The dielectric layer 10 has a rectangular planar shape and is formed with a length (in the X-axis direction) and a width (in the Y-axis direction) of approximately 5 mm, for example. The thickness (in the Z-axis direction) of the dielectric layer 10 is set according to the dielectric constant of the dielectric material constituting the dielectric layer 10 and the wavelength of radio waves to be used, and is, for example, 0.65 mm in this embodiment where radio waves in a 60 GHz band are used.

Examples of the dielectric material constituting the dielectric layer 10 include an insulating organic material such as FR4, BT resin, or polytetrafluoroethylene, or an insulating inorganic material such as ceramics. The dielectric constant of the dielectric layer 10 is not particularly limited, and can be set discretionally according to the frequency of the radio waves transmitted or received by the antenna element 100. For example, in the case of an application for transmitting and receiving electromagnetic waves in the 60 GHz band, a material with a dielectric constant of, for example, 3.6 is used as the dielectric substrate 10.

The first conductor layer 21 corresponds to a conductor layer formed on one surface side of the dielectric multilayer substrate, and in this embodiment, is a metal layer formed on a first main surface 10a (upper surface in FIGS. 1 and 2) of the dielectric layer 10. The first conductor layer 21 is configured as a radiation element of the antenna element 100.

The first conductor layer 21 is formed to have a smaller area than the second conductor layer 22 and is formed in a planar pattern whose planar shape is a rectangular planar element shape, for example. The planar element shape is, for example, a planar shape (patch shape) of a conductor portion that forms a radiation element such as a patch antenna. The size (length of each side) of the first conductor layer 21 is not particularly limited, and can be set discretionally according to the frequency band of the radio waves to be used. In this embodiment, the length of a long side 21L along the X-axis direction is approximately 1.6 mm and the length of a short side 21S along the Y-axis direction is approximately 1.0 mm.

Note that the planar shape of the first conductor layer 21 is not limited to the rectangular shape, but may be a polygon other than a rectangle, a circle, an oval, or a combination of those shapes. In addition, at least a part of the rectangle (for example, a side or a vertex) may be deformed into any shape.

The second conductor layer 22 corresponds to a conductor layer formed on the other surface side of the dielectric multilayer substrate, and in this embodiment, is a metal layer formed on a second main surface 10b (lower surface in FIGS. 1 and 2) on the side opposite to the first main surface 10a of the dielectric layer 10. The second conductor layer 22 is configured as a ground conductor plate of the antenna element 100. By being electrically connected to a ground potential G, the second conductor layer 22 is formed over the entire back surface 10b of the dielectric layer 10, but is of course not limited to this.

The metals constituting the first conductor layer 21 and the second conductor layer 22 are not particularly limited, and are, for example, copper and aluminum. The thickness of the first conductor layer 21 and the second conductor layer 22 is not particularly limited and may be formed with the same thickness as each other or with different thicknesses from each other.

The first interlayer connection portion 31 penetrates the dielectric layer 10 in its thickness direction (Z-axis direction) and connects the first conductor layer 21 to a power feed portion F. The first interlayer connection portion 31 is a cylindrical conductor electrically connected to the first conductor layer 21, and in this embodiment, is formed of a through-hole plating or an embedded via filled with a conductive material, which is provided in the dielectric layer 10. The second conductor layer 22 has an opening 22a formed with an opening diameter larger than the outer diameter of the first interlayer connection portion 31. The first interlayer connection portion 31 is electrically insulated from the second conductor layer 22 by being housed within the opening 22a without contact with a circumferential portion of the opening 22a. The annular region between the opening 22a and the first interlayer connection portion 31 may be filled with the same material as that of the dielectric layer 10 or a dielectric material different from the material of the dielectric layer 10.

The second interlayer connection portion 32 penetrates the dielectric layer 10 in its thickness direction (Z-axis direction) and electrically connects the first conductor layer 21 and the second conductor layer 22. The second interlayer connection portion 32 is a cylindrical conductor similar to the first interlayer connection portion 31, and in this embodiment, is formed of a through-hole plating or an embedded via filled with a conductive material, which is provided in the dielectric layer 10. The second interlayer connection portion 32 is formed to have the same diameter and the same height as those of the first interlayer connection portion 31.

The first interlayer connection portion 31 and the second interlayer connection portion 32 are connected to be perpendicular to the first conductor layer 21. Therefore, the length (height) of the first interlayer connection portion 31 and the second interlayer connection portion 32 corresponds to the thickness of the dielectric layer 10 (0.65 mm). As shown in FIG. 1, the first conductor layer 21 includes a first region 211 to which the first interlayer connection portion 31 is connected, and a second region 212 to which the second interlayer connection portion 32 is connected. The first region 211 and the second region 212 are both disposed in the surface of the first conductor layer 21 and disposed away from the circumferential portion of the first conductor layer 21.

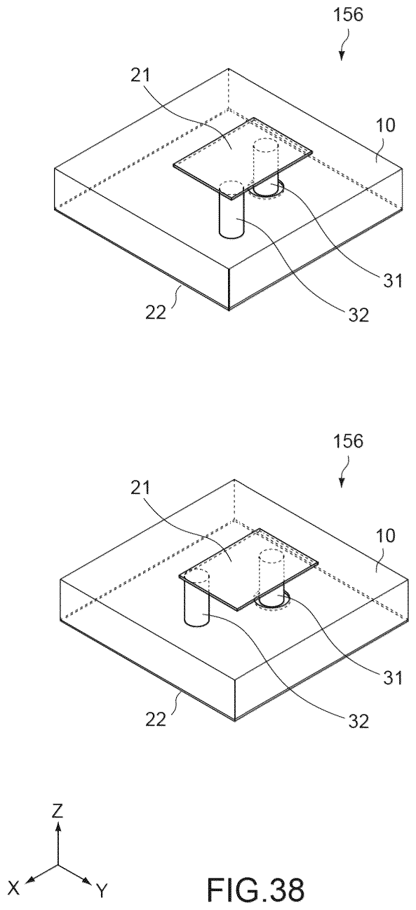

In this embodiment, the first region 211 and the second region 212 are disposed at a symmetrical position with respect to the center of the first conductor layer 21 in a direction parallel to the long side 21L (X-axis direction). Not limited to this, the first region 211 and the second region 212 may be disposed in a direction intersecting with the direction parallel to the long side 21L (X-axis direction), as will be described below (see FIG. 38).

The antenna element 100 of this embodiment configured as described above is configured as a loop antenna with an axial center parallel to the width direction (Y-axis direction) by the first conductor layer 21, the first interlayer connection portion 31, and the second interlayer connection portion 32.

In the antenna element 100 of this embodiment, the length of each side (long side 21L, short side 21S) of the first conductor layer 21 is set such that the frequency band of the radio waves to be used is 60 GHz (e.g., 57 GHz to 64 GHz). In other words, since the first conductor layer 21 is formed into a planar element shape having a length and width larger than the axis diameter of the interlayer connection portions 31 and 32 and the arrangement interval therebetween, the current density is concentrated at the circumferential portion of the first conductor layer 21, and thus the fractional bandwidth can be increased by setting the length of each side of the first conductor layer 21.

In addition, a loop length (effective length including wavelength shortening due to the dielectric constant of the dielectric layer 10) formed by the first interlayer connection portion 31, the second interlayer connection portion 32, and the first conductor layer 21 is set to be equal to or less than one wavelength of the radio waves to be used, more favorably, a size equivalent to half the wavelength of that radio waves. In this embodiment, the above effective length is 2.477 mm, which is equivalent to half the wavelength of the radio waves of 60 GHz.

According to the antenna element 100 of this embodiment, it has a plurality of resonant frequencies including a resonant frequency corresponding to the loop length and a resonant frequency corresponding to the circumferential length of the first conductor layer 21, and thus the fractional bandwidth (value obtained by dividing the bandwidth by the center frequency) that can be covered by a single element can be increased.

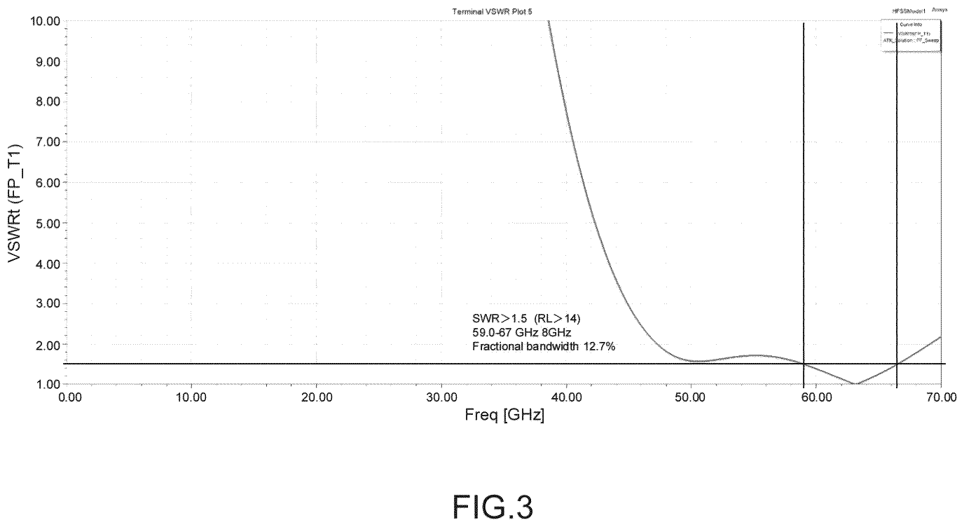

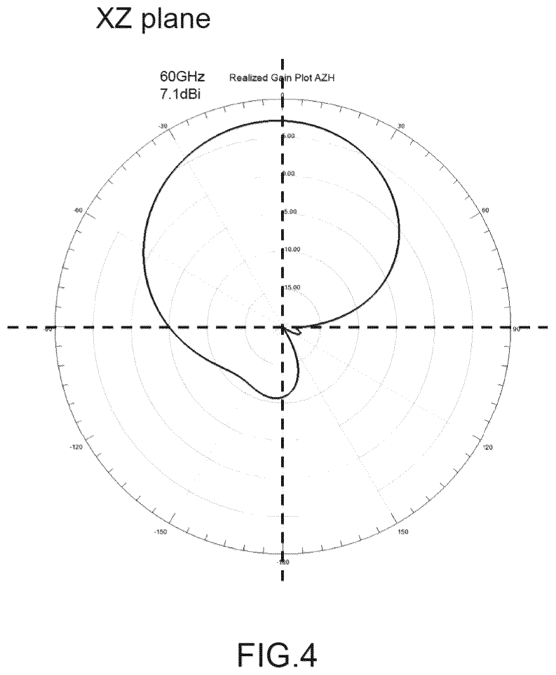

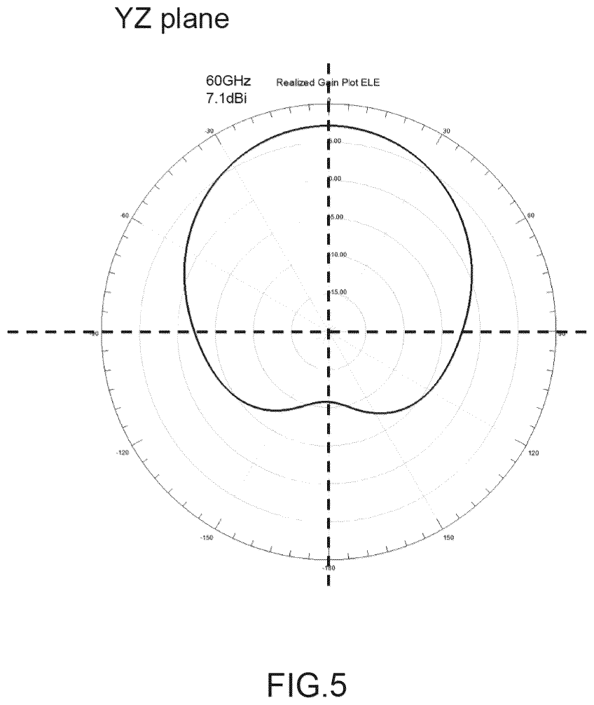

FIG. 3 is a simulation result showing an example of a voltage standing wave ratio (VSWR) of the antenna element 100. FIG. 4 is a simulation result showing radiation characteristics of the antenna element 100 in an azimuth plane (XZ plane) in 60 GHz, and FIG. 5 is a simulation result showing radiation characteristics of the antenna element 100 in an elevation plane (YZ plane) in 60 GHz. In FIGS. 4 and 5, the 0° direction (upper direction) corresponds to a top surface direction (+Z direction).

As shown in FIG. 3, the frequency band with a VSWR ratio equal to or less than 1.5 was from 59 GHz to 67 GHz, and the fractional bandwidth was 12.7%. In addition, as shown in FIGS. 4 and 5, balanced directivity characteristics were obtained over a wide range toward the top surface direction.

As described above, according to this embodiment, antenna characteristics resonating over a wide bandwidth can be obtained despite the single element structure.

### Comparative Examples

Subsequently, the radiation characteristics of the antenna element 100 of this embodiment will be described, compared with antenna structures according to Comparative Examples 1 and 2 to be described below.

### Comparative Example 1

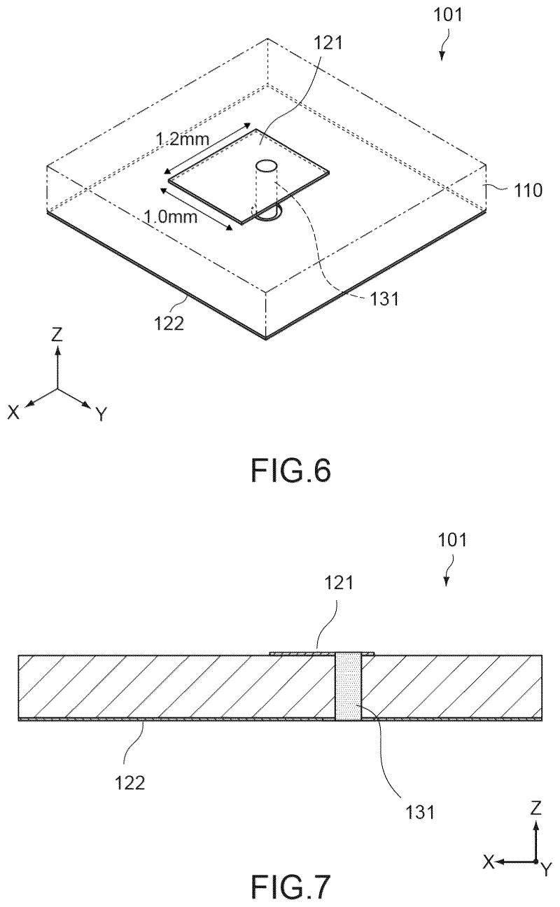

FIG. 6 is a transparent perspective view of an antenna element 101 according to Comparative example 1, and FIG. 7 is a cross-sectional side view of the antenna element 101. This antenna element 101 shows a typical structure of a back-side feeding patch antenna.

In other words, the antenna element 101 includes a dielectric layer 110, a first conductor layer 121 serving as a radiation element formed on a front surface of the dielectric layer 110, a second conductor layer 122 serving as a ground conductor plate formed on a back surface of the dielectric layer 110, and an interlayer connection portion 131 that penetrates the dielectric layer 110 and connects the first conductor layer 121 to a power feed point. The interlayer connection portion 131 is electrically insulated from the second conductor layer 122. Here, the shape of the first conductor layer 121 was a rectangular shape having a long side of 1.2 mm and a short side of 1.0 mm.

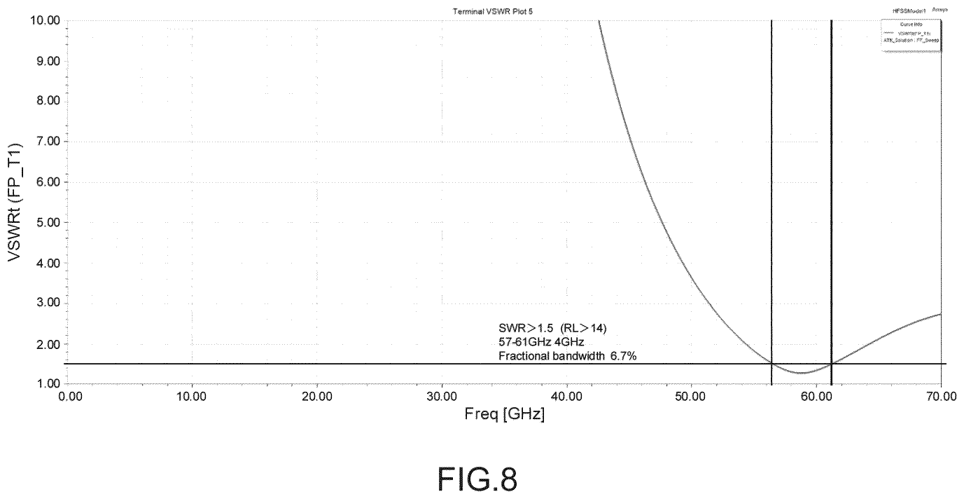

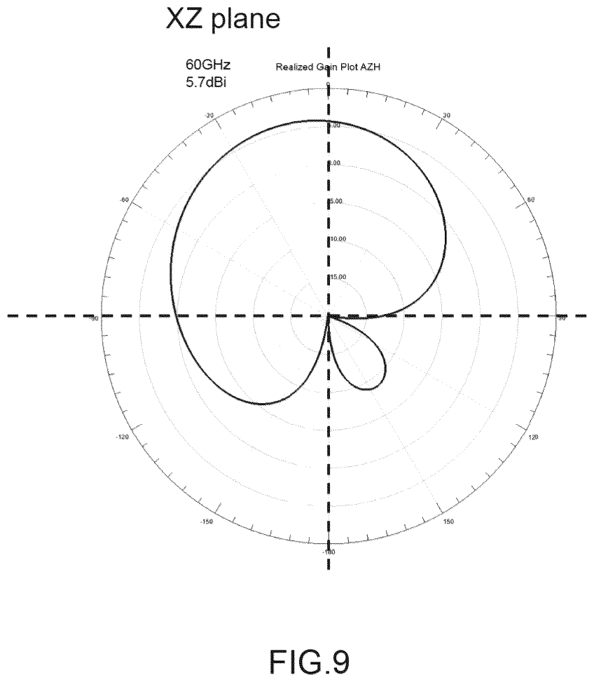

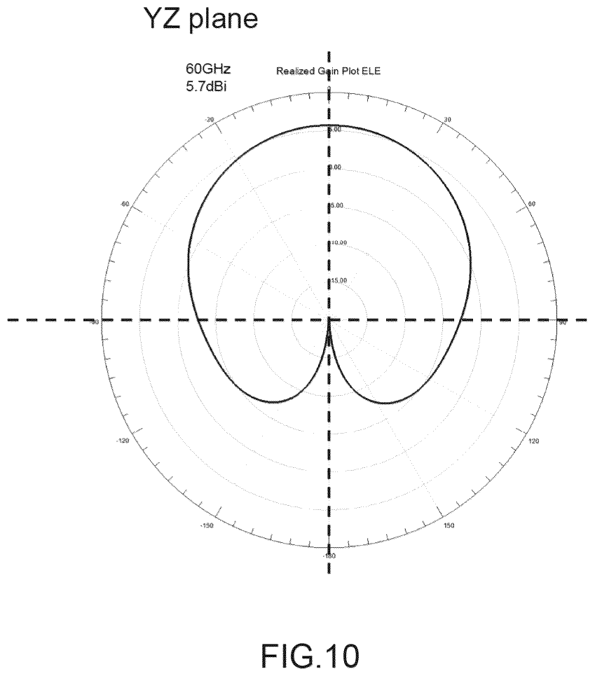

FIG. 8 is a simulation result showing an example of a voltage standing wave ratio (VSWR) of the antenna element 101. FIG. 9 is a simulation result showing radiation characteristics of the antenna element 101 in an azimuth plane (XZ plane) in 60 GHz, and FIG. 10 is a simulation result showing radiation characteristics of the antenna element 101 in an elevation plane (YZ plane) in 60 GHz. In FIGS. 9 and 10, the 0° direction (upper direction) corresponds to a top surface direction (+Z direction).

As shown in FIG. 8, in the antenna element 101 of Comparative example 1, the frequency band with a VSWR ratio equal to or less than 1.5 was from 57 GHz to 61 GHz, and the fractional bandwidth was 6.7%. In contrast, according to the antenna element 100 of this embodiment, the fractional bandwidth is 12.7% as described above (see FIG. 3), and thus the fractional bandwidth can be increased by approximately twice as compared to Comparative example 1. This makes it possible to achieve a wider frequency band than the antenna element 101 according to Comparative example 1.

Note that, for the antenna directivity, characteristics almost equal to those of the antenna element 101 of Comparative example 1 shown in FIGS. 9 and 10 were obtained. Therefore, according to this embodiment, the frequency band can be expanded while having the antenna directivity equal to that of the patch antenna structure.

### Comparative Example 2

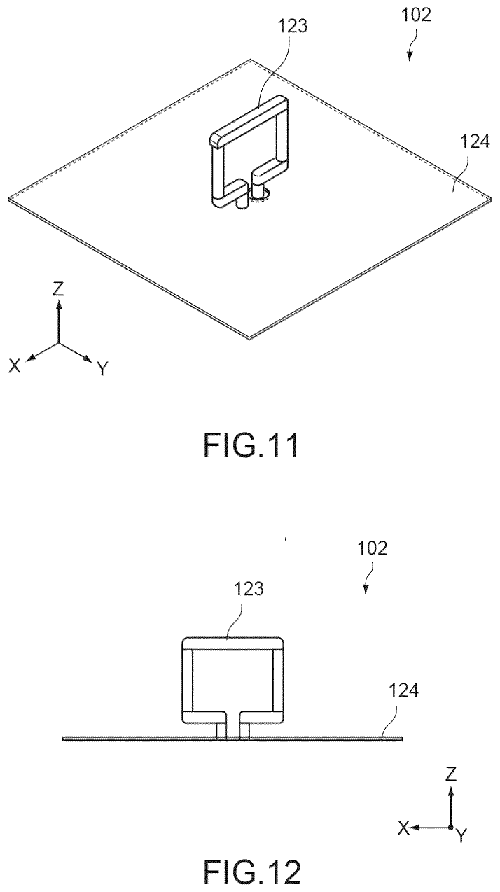

FIG. 11 is a perspective view of an antenna element 102 according to Comparative example 2, and FIG. 12 is a side view of the antenna element 102. This antenna element 102 includes an antenna structure body 123 having a loop shape formed to be perpendicular to a ground conductor plate 124. One end of the antenna structure body is connected to a power feed point, and another end is connected to the ground conductor plate 124. The loop length was set to a size equivalent to half a wavelength of a 60 GHz radio wave.

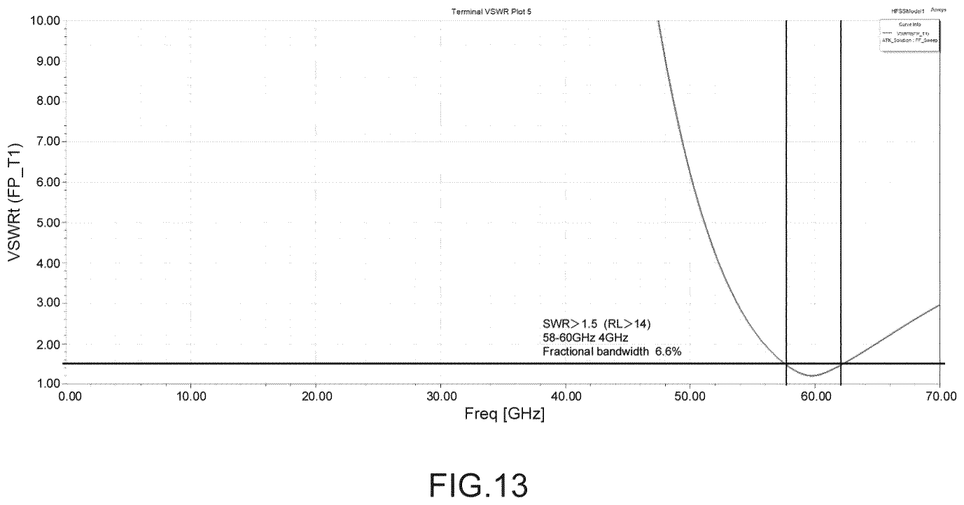

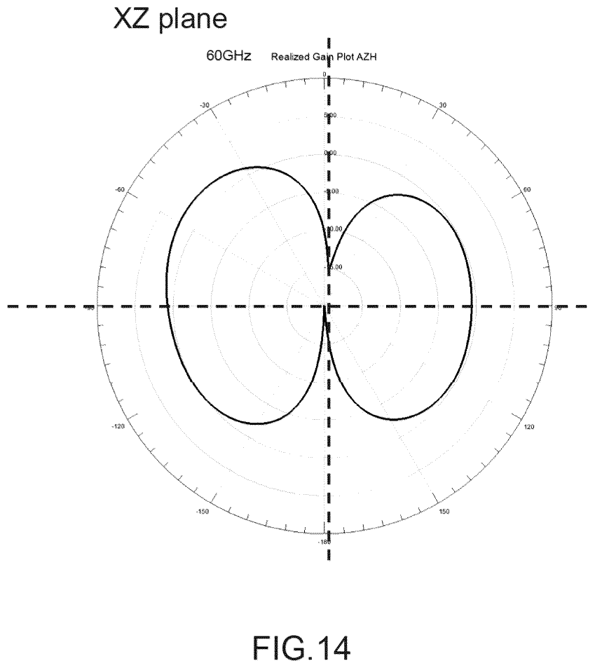

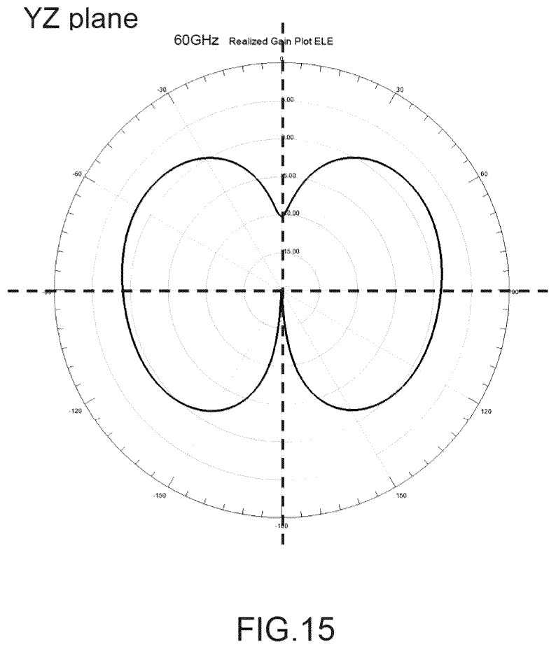

FIG. 13 is a simulation result showing an example of a voltage standing wave ratio (VSWR) of the antenna element 102. FIG. 14 is a simulation result showing radiation characteristics of the antenna element 102 in an azimuth plane (XZ plane) in 60 GHz, and FIG. 15 is a simulation result showing radiation characteristics of the antenna element 102 in an elevation plane (YZ plane) in 60 GHz. In FIGS. 14 and 15, the 0° direction (upper direction) corresponds to a top surface direction (+Z direction).

As shown in FIG. 13, in the antenna element 102 of Comparative example 2, the frequency band with a VSWR ratio equal to or less than 1.5 was from 58 GHz to 60 GHz, and the fractional bandwidth was 6.6%. In contrast, according to the antenna element 100 of this embodiment, the fractional bandwidth is 12.7% as described above (see FIG. 3), and thus the fractional bandwidth can be increased by approximately twice as compared to Comparative example 2. This makes it possible to achieve a wider frequency band than the antenna element 101 according to Comparative example 1.

In addition, for the directivity, unlike Comparative example 1, figure-8 characteristics like a dipole antenna are obtained, which can be a structure not suitable for a directional antenna to a radiating surface (top surface) that is used in a millimeter-wave range. Therefore, according to this embodiment, it is possible to achieve a wider frequency band while achieving balanced directivity characteristics over a wide range toward the top surface direction, as compared to a typical loop antenna structure.

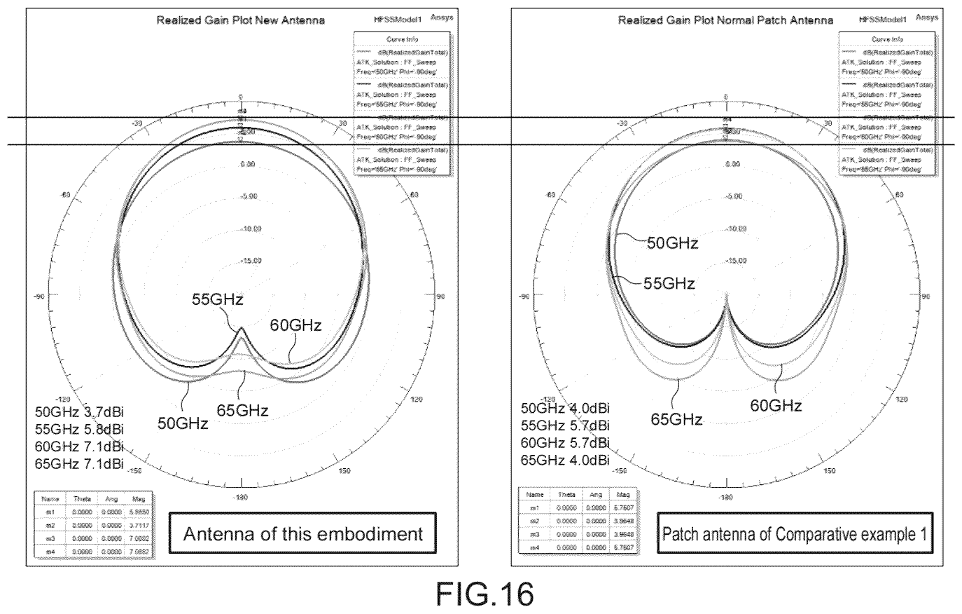

FIG. 16 is a simulation result obtained by comparing the antenna characteristics and directivity of the antenna element 100 of this embodiment and the antenna element 101 of Comparative example 1. Here, each element was formed in the same size at a resonant frequency of 60 GHz, and the antenna characteristics and the directivity from 50 to 65 GHz were measured at intervals of 5 GHz.

As shown in FIG. 16, the antenna element 100 of this embodiment obtained directivity characteristics similar to those of the antenna element 101 of Comparative example 1. On the other hand, according to this embodiment, the antenna gain in the top surface direction from 55 GHz to 65 GHz exceeded that of Comparative example 1.

In order to widen the bandwidth and increase the gain of antennas, techniques such as providing an array form that requires multiple antenna elements or increasing the number of layers in a laminated substrate and adding a pattern for reflection and widening of bandwidth in the intermediate layers have been used so far, but according to this embodiment, the bandwidth can be widened at a low cost and by a simple method.

### Second Embodiment

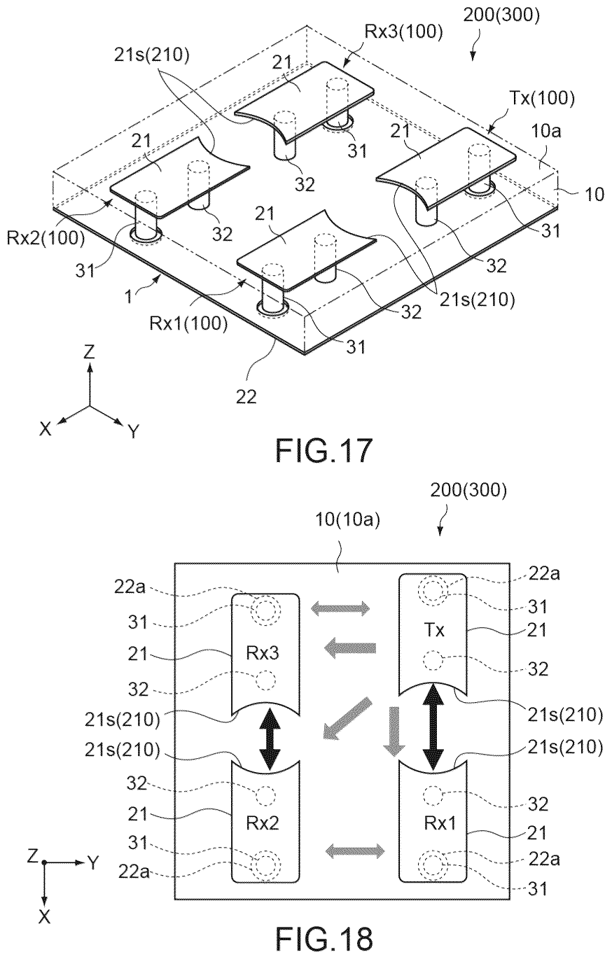

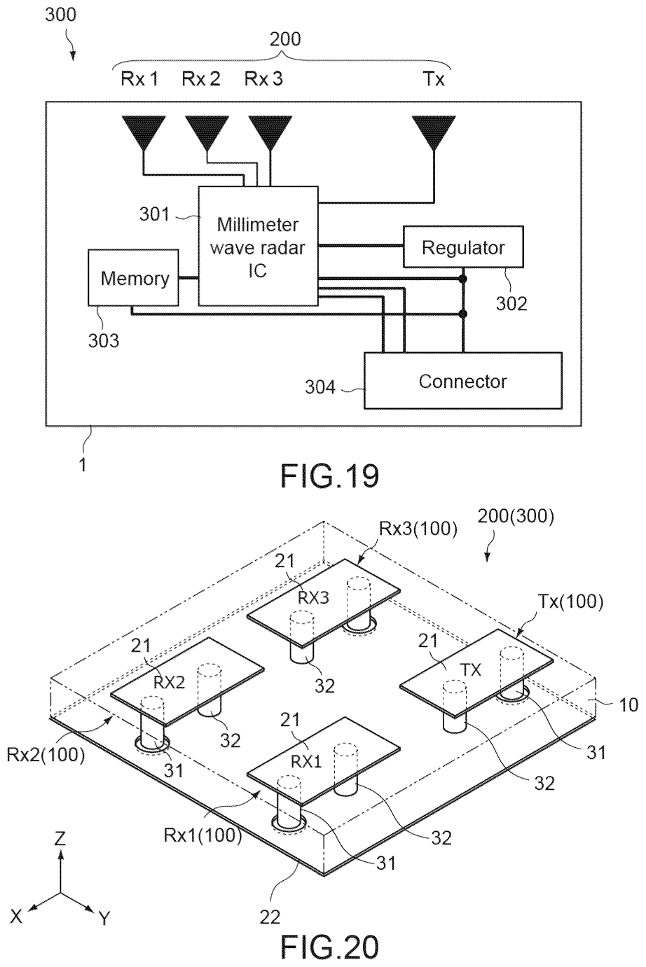

FIG. 17 is a transparent perspective view of an antenna module 300 according to a second embodiment of the present embodiment, FIG. 18 is a plan view of the antenna module 300, and FIG. 19 is a block diagram showing a circuit configuration of the antenna module 300. Note that portions corresponding to those of the first embodiment described above in the figures are denoted by the same symbols, and descriptions thereof will be omitted.

The antenna module 300 of this embodiment includes an antenna array 200 and a signal processing circuit 301 (FIG. 19). The antenna array 200 and the signal processing circuit 301 are formed on or mounted on a common dielectric multilayer substrate 1.

### Antenna Array

The antenna array 200 includes a plurality of antenna elements 100. The plurality of antenna elements 100 includes one transmission antenna Tx and three reception antennas Rx1, Rx2, and Rx3. Each antenna element 100 has the same configuration and configured to be similar to the antenna element described in the first embodiment. The number of transmission antennas is not limited to one, but may be two or more. In addition, the number of reception antennas is not limited to three, but may be two, or four or more.

The first conductor layers 21 of the respective antenna elements 100 are arrayed independently on a first main surface 10a of the dielectric layer 10. Each first conductor layer 21 is formed in a similar planar element shape, and in this embodiment, is formed in a schematic rectangular shape having a long side in the X-axis direction and a short side in the Y-axis direction. Those antenna elements 100 are arrayed in a matrix along the X-axis direction and the Y-axis direction on the first main surface 10a of the dielectric layer 10 as shown in FIG. 18.

On the other hand, the second conductor layers 22 of the respective antenna elements 100 are formed of a common conductor layer connected to a ground potential. The second conductor layer 22 is provided with an opening 22a in a region in which the first interlayer connection portion 31 of each antenna element 100 is formed, so that the second conductor layer 22 and each first interlayer connection portion 31 are electrically insulated. The first interlayer connection portion 31 of each antenna element 100 is connected to the signal processing circuit 301 via a signal transmission line (not shown) formed in a second main surface 10b of the dielectric layer 10. Various signal line paths such as microstrip lines, strip lines, and coplanar wave guide lines can be employed as the signal transmission lines.

### Signal Processing Circuit

The signal processing circuit 301 is a millimeter wave radar IC that generates millimeter wave signals to be transmitted to the transmission antenna Tx and processes the millimeter wave signals received by the reception antennas Rx1 to Rx3 to calculate the angle of arrival, and corresponds to a power feed portion. The dielectric multilayer substrate 1 is further equipped with, as shown in FIG. 19, a regulator 302 that adjusts a voltage to be supplied to the signal processing circuit 301, a memory 303 that stores driving parameters of the signal processing circuit 301 and the like, a connector 304 for electrically connecting those signal processing circuit, regulator 302, and memory 303 to an external apparatus (not shown), and the like.

The antenna module 300 of this embodiment is configured as a MIMO (Multi Input Multi Output) radar antenna. According to this embodiment, since the respective antennas for transmission and reception are mounted on the same substrate, the action and effect similar to those of the first embodiment described above can be obtained, and an antenna apparatus can be made smaller and thinner.

### Improvement of Isolation Characteristics

As described above, the first conductor layer 21 of each antenna element 100 constituting the antenna array 200 has a rectangular planar shape having a long side parallel to the X-axis direction and a short side parallel to the Y-axis direction. Therefore, when each antenna element 100 is arrayed on the first main surface 10a of the square-shaped dielectric layer 10, the interval between antenna elements 100 adjacent to each other in the X-axis direction is smaller than the interval between antenna elements 100 adjacent to each other in the Y-axis direction.

In this regard, in this embodiment, notches 210 are provided to the short sides 21s facing each other of the two first conductor layers 21 arrayed in the X-axis direction to partially expand the interval between those two first conductor layers 21. This allows the isolation characteristics between the two antenna elements 100 adjacent to each other in the X-axis direction (between the transmission antenna Tx and the reception antenna Rx1, and between the two reception antennas Rx2 and Rx3) can be improved, as compared to the antenna array 200 without notches 210 as shown in, for example, FIG. 20.

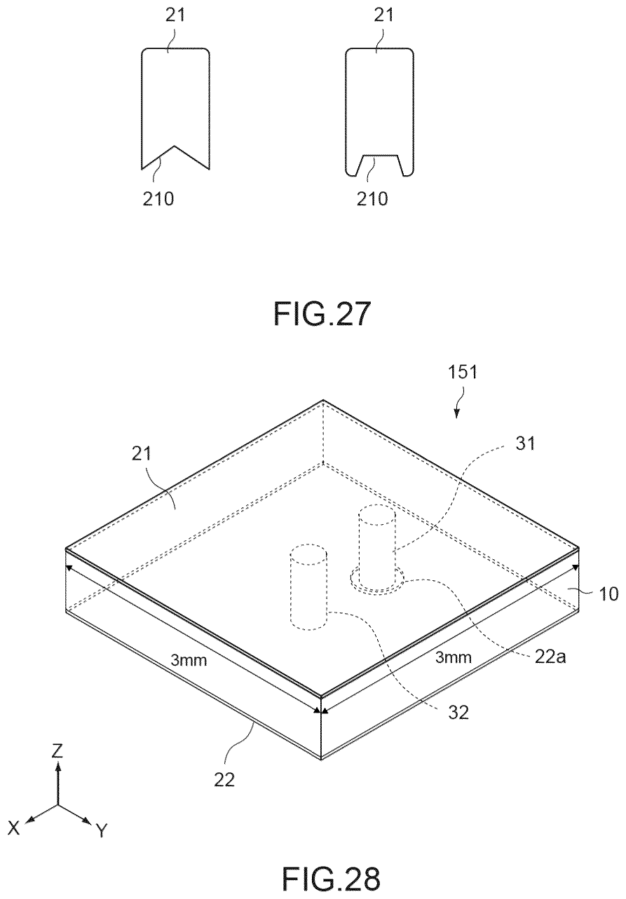

The shape of the notch 210 is not particularly limited, and in this embodiment, is an arc-shaped. Other than this, as shown in FIG. 27, the notch 210 may be formed in a triangular shape, or in a rectangular or trapezoidal shape. Providing the notch 210 to a part of the short side 21S of the first conductor layer 21 in such a manner makes it possible to prevent the circumferential length of the first conductor layer 21 from changing significantly. This can improve the isolation characteristics while ensuring a wide bandwidth.

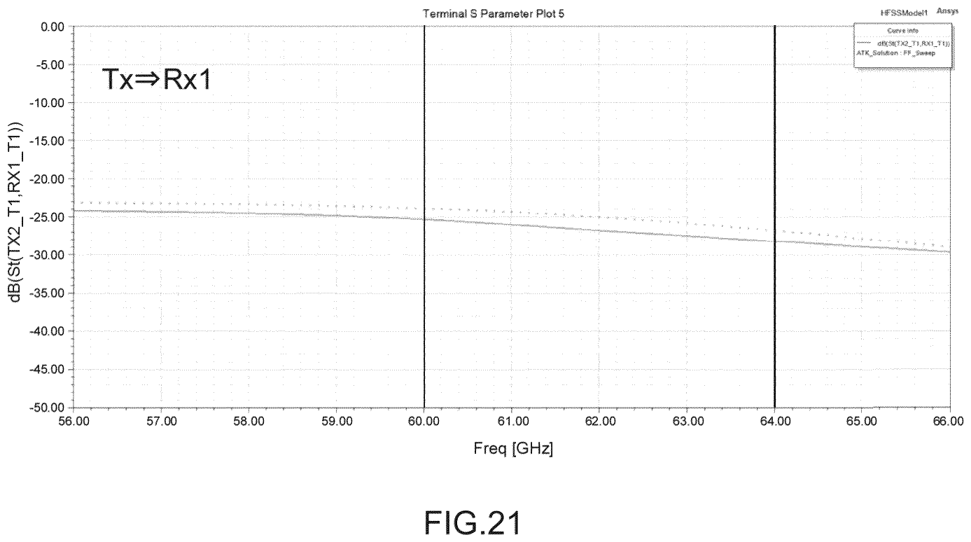

FIG. 21 is a simulation result showing the isolation characteristics of the reception antenna Rx1 with respect to the transmission antenna Tx. In the figure, the solid line represents the characteristics in the case of including the notch 210 (hereinafter, also referred to as “with isolation processing”), and the broken line represents the characteristics in the case of including no notch 210 (hereinafter, also referred to as “without isolation processing”). As shown in the figure, the case with isolation processing shows an improvement of approximately 1 dB, as compared to the case without isolation processing.

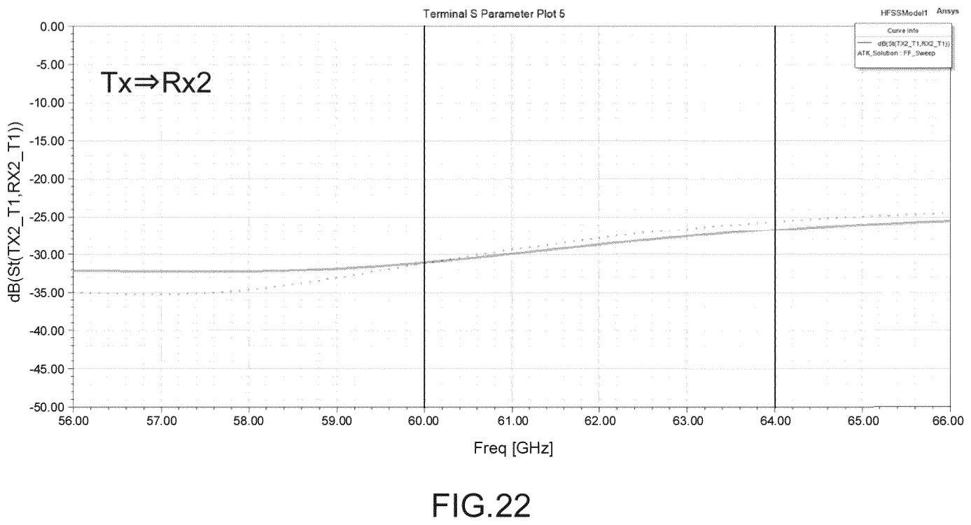

FIG. 22 is a simulation result showing the isolation characteristics of the reception antenna Rx2 with respect to the transmission antenna Tx. In the figure, the solid line represents the characteristics in the case with isolation processing, and the broken line represents the characteristics in the case without isolation processing. As shown in the figure, in this experiment, there was no significant difference between the case with isolation processing and the case without isolation processing. This is thought to be due to the fact that the transmission antenna Tx and the reception antenna Rx2 are located diagonally to each other and the physical distance between them is large.

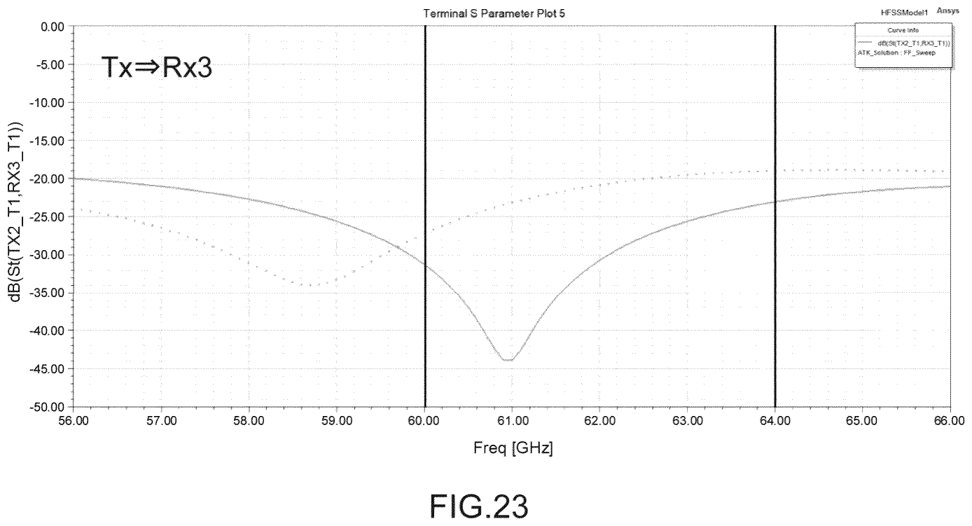

FIG. 23 is a simulation result showing the isolation characteristics of the reception antenna Rx3 with respect to the transmission antenna Tx. In the figure, the solid line represents the characteristics in the case with isolation processing, and the broken line represents the characteristics in the case without isolation processing. As shown in the figure, the case with isolation processing shows a great improvement in the band of 60 GHz to 64 GHz, as compared to the case without isolation processing. This is thought to be due to the fact that the transmission antenna Tx and the reception antenna Rx3 face each other at the long sides of the first conductor layers 21 and are not affected by the formation of the notches 210, but since the current density of the circumferential portion of the first conductor layer 21 is high, the shape effect of the notch 210 provides a filter-like function at a specific frequency.

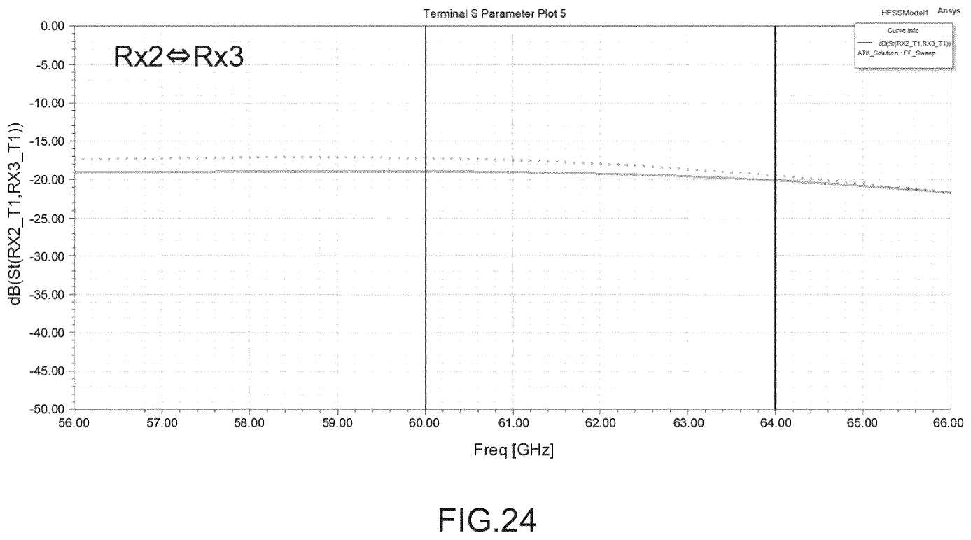

FIG. 24 is a simulation result showing the isolation characteristics between the reception antenna Rx2 and the reception antenna Rx3. In the figure, the solid line represents the characteristics in the case with isolation processing, and the broken line represents the characteristics in the case without isolation processing. As shown in the figure, the case with isolation processing shows an improvement of approximately 2 dB, as compared to the case without isolation processing.

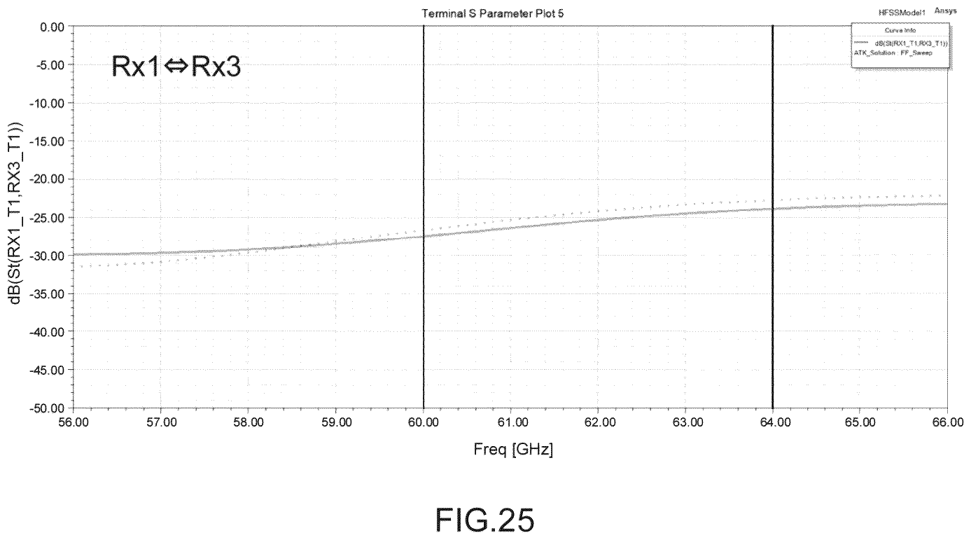

FIG. 25 is a simulation result showing the isolation characteristics between the reception antenna Rx1 and the reception antenna Rx3. In the figure, the solid line represents the characteristics in the case with isolation processing, and the broken line represents the characteristics in the case without isolation processing. As shown in the figure, in this experiment, there was no significant difference between the case with isolation processing and the case without isolation processing. This is thought to be due to the fact that the reception antenna Rx1 and the reception antenna Rx3 are located diagonally to each other and the physical distance between them is large.

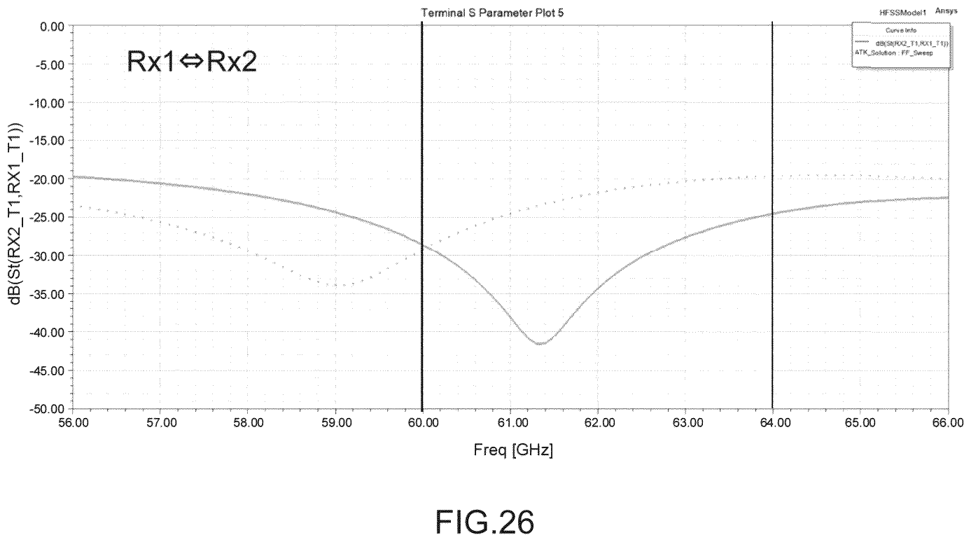

FIG. 26 is a simulation result showing the isolation characteristics between the reception antenna Rx1 and the reception antenna Rx2. In the figure, the solid line represents the characteristics in the case with isolation processing, and the broken line represents the characteristics in the case without isolation processing. As shown in the figure, the case with isolation processing shows a great improvement in the band of 60 GHz to 64 GHz, as compared to the case without isolation processing. This is thought to be due to the fact that the shape effect of the notch 210 provides a filter-like function at a specific frequency, similar to the result shown in FIG. 23.

### Third Embodiment

### Another Configuration Example of Antenna Element

Subsequently, another configuration example of the antenna element according to the present technology will be described. Note that portions corresponding to those of FIG. 1 in the figures are denoted by the same symbols, and detailed descriptions thereof will be omitted.

An antenna element 151 shown in FIG. 28 is different from the antenna element 100 shown in FIG. 1 in that the first conductor layer 21 as a radiation element is formed to have the same area as that of the second conductor layer 22 as a ground conductor plate. Here, the length of each side of the first conductor layer 21 and the second conductor layer 22 was set to 3 mm.

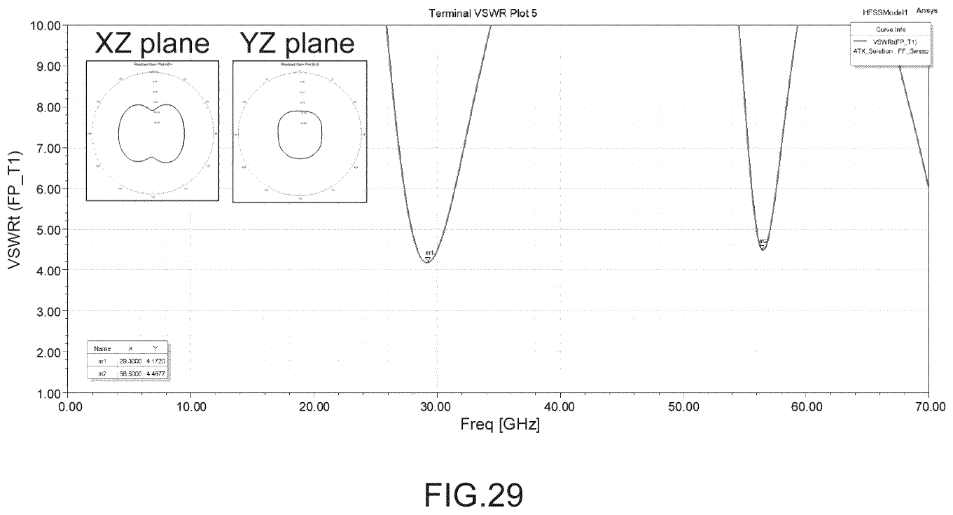

FIG. 29 shows simulation results showing voltage standing wave ratio (VSWR) characteristics of the antenna element 151, and radiation characteristics in an azimuth plane (XZ plane) and an elevation plane (YZ plane) in 60 GHz. As shown in the figure, the area of the first conductor layer 21 was too large, and the resonance state was changed, thus making it difficult to establish the antenna for the 60 GHz band. Therefore, the first conductor layer 21 needs be formed with an area smaller than, for example, at least the second conductor layer 22, and it is suitable to optimize the circumferential length of the first conductor layer 21 according to the bandwidth used.

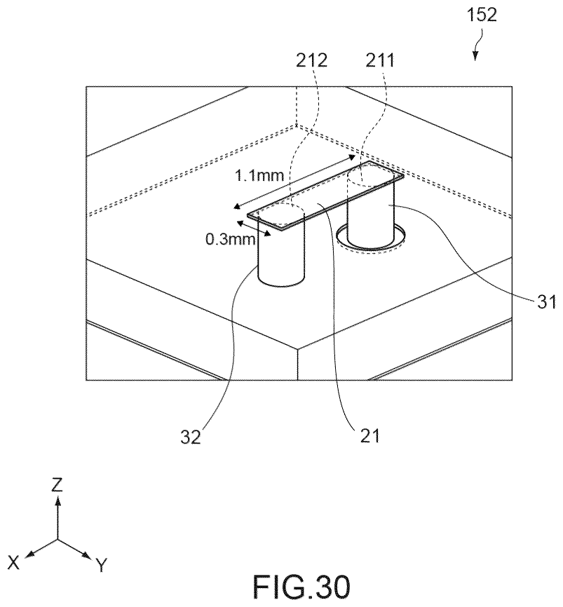

An antenna element 152 shown in FIG. 30 is different from the antenna element 100 shown in FIG. 1 in that, as viewed from the Z-axis direction, the circumferential portion (long side and short side) of the first conductor layer 21 as a radiation element is formed in a strap shape that comes into contact with the outer circumferential portions of the first interlayer connection portion 31 (first region 211) and the second interlayer connection portion 32 (second region 212). Here, the length of the short side of the first conductor layer 21 was set to 0.3 mm, and the length of the long side was set to 1.1 mm.

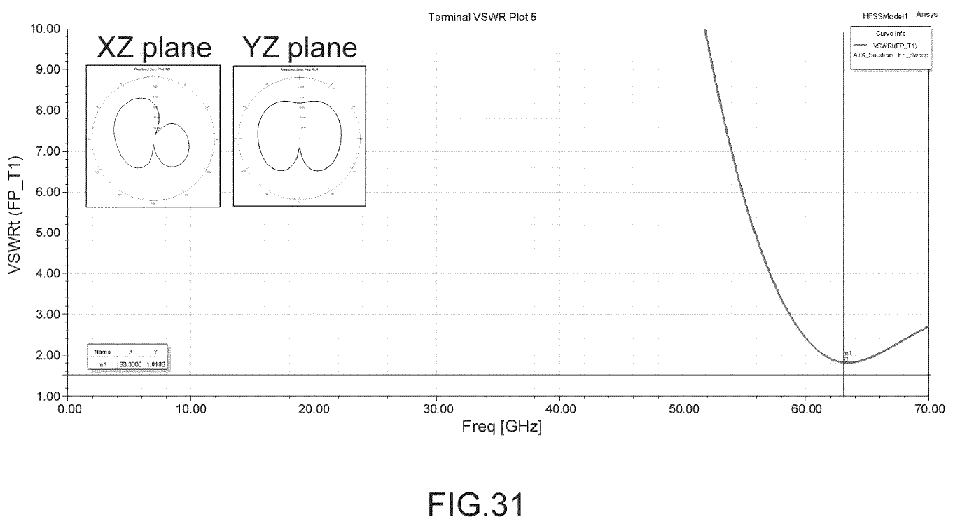

FIG. 31 shows simulation results showing voltage standing wave ratio (VSWR) characteristics of the antenna element 152, and radiation characteristics in an azimuth plane (XZ plane) and an elevation plane (YZ plane) in 60 GHz. As shown in the figure, resonance occurred in the 60 GHz band, but the radiation characteristics of the antenna remained in the directivity of the loop antenna.

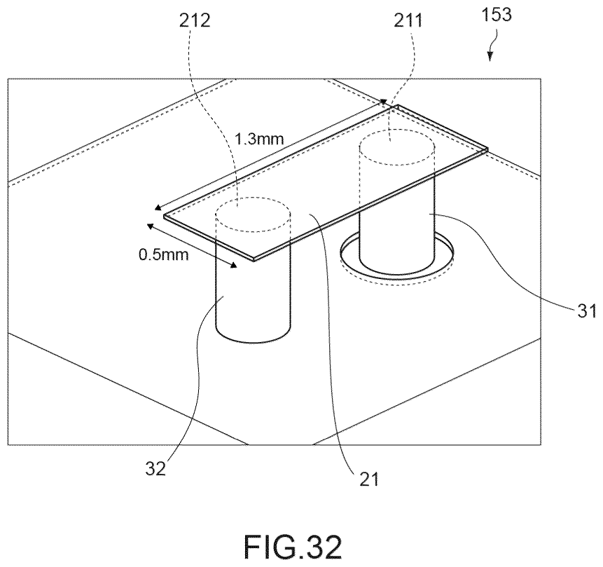

On the other hand, an antenna element 153 shown in FIG. 32 is different from the antenna element 152 shown in FIG. 30 in that, as viewed from the Z-axis direction, the circumferential portion (long side and short side) of the first conductor layer 21 as a radiation element is formed in a strap shape such that the outer circumferential portions of the first interlayer connection portion 31 (first region 211) and the second interlayer connection portion 32 (second region 212) are located inwardly relative to the circumferential portion of the first conductor layer 21. Here, the length of the short side of the first conductor layer 21 was set to 0.5 mm, and the length of the long side was set to 1.3 mm.

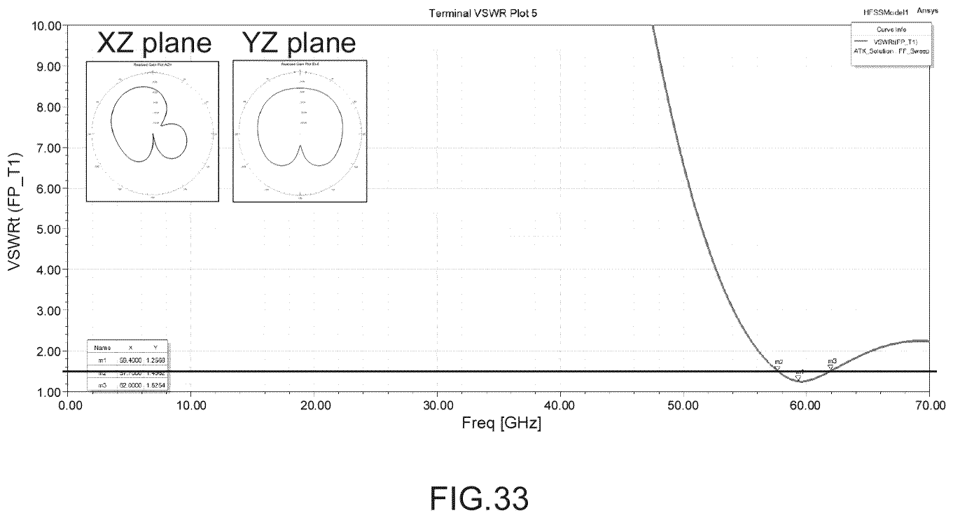

FIG. 33 shows simulation results showing voltage standing wave ratio (VSWR) characteristics of the antenna element 153, and radiation characteristics in an azimuth plane (XZ plane) and an elevation plane (YZ plane) in 60 GHz. As shown in the figure, the band starts to expand around the 60 GHz band, and the radiation characteristics to the top surface increases as an antenna.

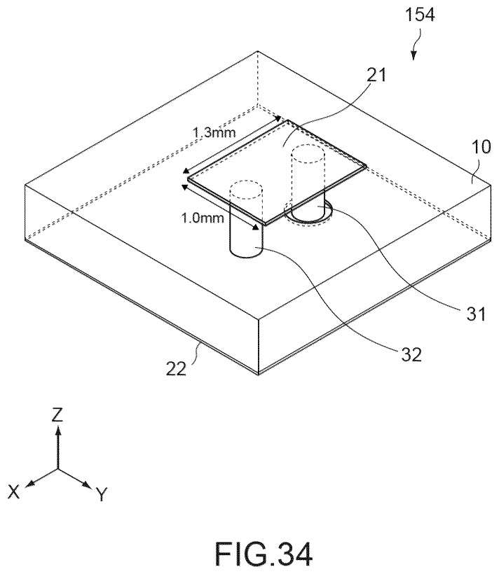

In addition, an antenna element 154 shown in FIG. 34 is different from the antenna element 153 shown in FIG. 32 in that the length of the short side of the first conductor layer 21 as a radiation element is set to 1.0 mm, and the length of the long side is set to 1.3 mm.

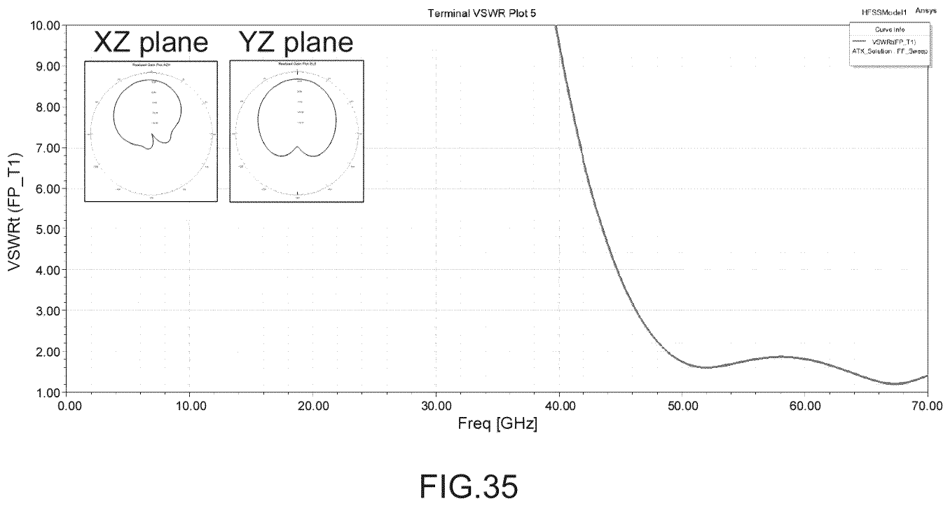

FIG. 35 shows simulation results showing voltage standing wave ratio (VSWR) characteristics of the antenna element 154, and radiation characteristics in an azimuth plane (XZ plane) and an elevation plane (YZ plane) in 60 GHz. As shown in the figure, it is found that the band further expands, and the radiation pattern of the antenna is optimized in the top surface direction.

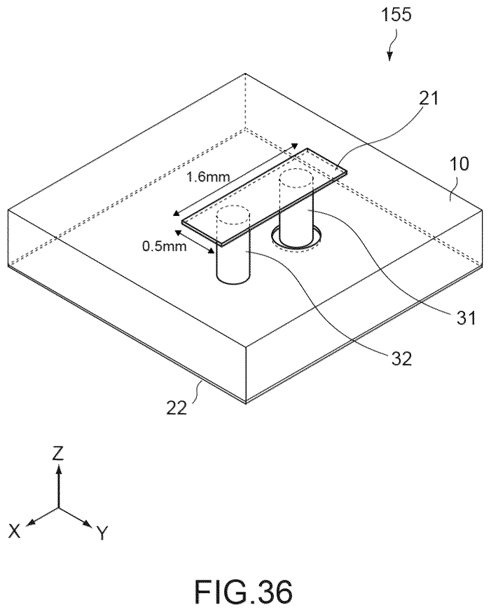

Further, an antenna element 155 shown in FIG. 36 is different from the antenna element 154 shown in FIG. 34 in that the length of the short side of the first conductor layer 21 as a radiation element is set to 0.5 mm, and the length of the long side is set to 1.6 mm.

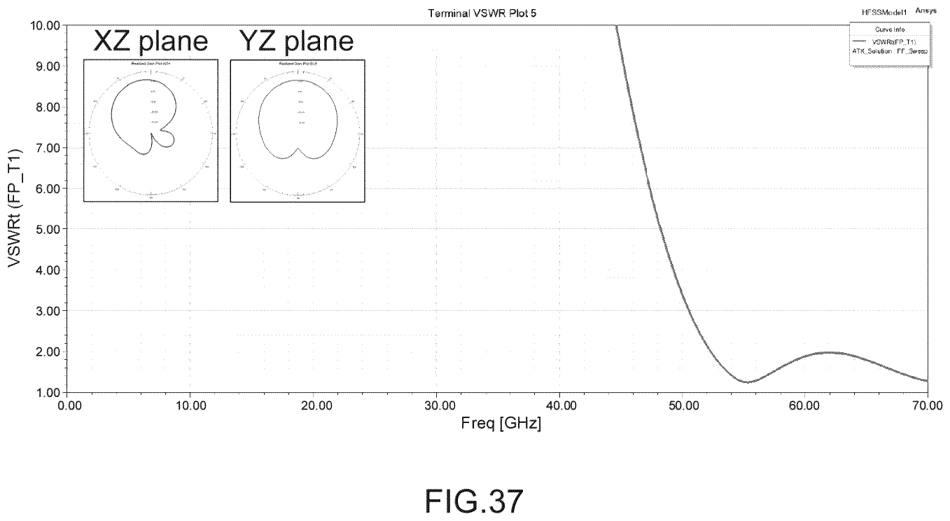

FIG. 37 shows simulation results showing voltage standing wave ratio (VSWR) characteristics of the antenna element 155, and radiation characteristics in an azimuth plane (XZ plane) and an elevation plane (YZ plane) in 60 GHz. As shown in the figure, it is found that a plurality of resonances is generated in the Y-axis direction as well and the band further expands, and thus the radiation pattern of the antenna becomes stronger to the top surface.

Two antenna elements 156 shown in FIG. 38 are different from the antenna element 100 shown in FIG. 1 in that the first interlayer connection portion 31 and the second interlayer connection portion 32 connected to the first conductor layer 21 as a radiation element are disposed in a direction intersecting with the direction parallel to the long side (the X-axis direction). Here, provided is an example in which the second interlayer connection portion 32 is disposed at a corner of the first conductor layer 21.

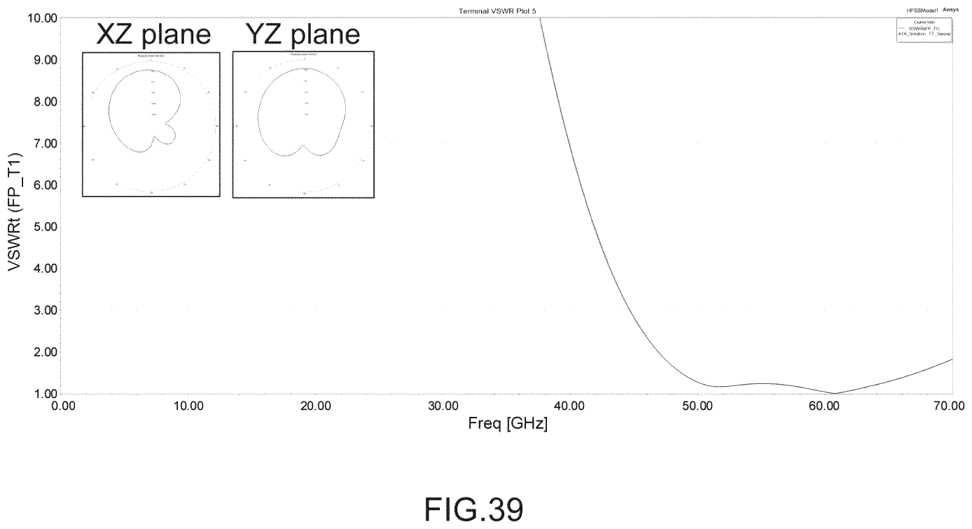

FIG. 39 shows simulation results showing voltage standing wave ratio (VSWR) characteristics of the antenna element 156, and radiation characteristics in an azimuth plane (XZ plane) and an elevation plane (YZ plane) in 60 GHz. As shown in the figure, the simulation results similar to those of the VSWR characteristics (FIG. 3) and the radiation characteristics (FIGS. 4 and 5) of the antenna element 100 shown in FIG. 1 are obtained, so that the action and effect similar to those of the first embodiment can be obtained also in this configuration example.

### Fourth Embodiment

### Another Example of Improvement of Isolation Characteristics

Next, a fourth embodiment of the present technology will be described. In the fourth embodiment, another example in a form of improving the isolation characteristics described in the second embodiment will be described.

Here, in the second embodiment described above, the method of improving the isolation characteristics by providing the notches 210 to the short sides facing each other in the X-axis direction of the respective first conductor layers 21 has been described. On the other hand, in the fourth embodiment, the isolation characteristics are further improved by adding improvements from another perspective in addition to the notches 210.

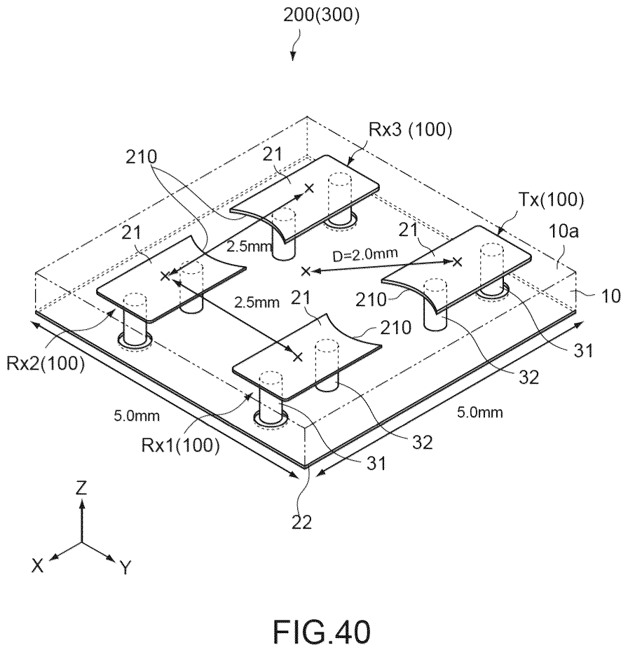

In the description here, first, an example of a form corresponding to the second embodiment described above will be described. FIG. 40 is a view showing an example of an antenna module 300 corresponding to the second embodiment described above.

As shown in FIG. 40, the antenna module 300 (antenna array 200) includes a plurality of antenna elements 100, and the plurality of antenna elements 100 includes one transmission antenna Tx and three reception antennas Rx1, Rx2, and Rx3. The first conductor layers 21 of the transmission antenna Tx and the reception antennas Rx1, Rx2, and Rx respectively include notches 210 in the short sides facing each other in the X-axis direction.

The antenna module 300 has a rectangular shape in the plane direction, and in this example, the length in the X-axis direction is set to 5.0 mm, and the width in the Y-axis direction is set to 5.0 mm.

In addition, in the Y-axis direction, a distance between the central position of the reception antenna Rx1 and the central position of the reception antenna Rx2 and a distance between the central position of the reception antenna Rx1 and the central position of the reception antenna Rx3 are each set to 2.5 mm. In addition, in the X-axis direction, a distance between the central position of the reception antenna Rx2 and the central position of the reception antenna Rx3 and a distance between the central position of the reception antenna Rx1 and the central position of the reception antenna Rx3 are each set to 2.5 mm.

In addition, in the XY-direction (plane direction), a distance D between the central position of the transmission antenna Tx and the central position of the three reception antennas Rx1, Rx3, and Rx3 is set to 2 mm. Note that the central position of the three reception antennas Rx1, Rx3, and Rx3 in the plane direction is located at the midpoint between the central position of the reception antenna Rx1 and the central position of the reception antenna Rx2 in the Y-axis direction, and also at the midpoint between the central position of the reception antenna Rx2 and the central position of the reception antenna Rx3 in the X-axis direction.

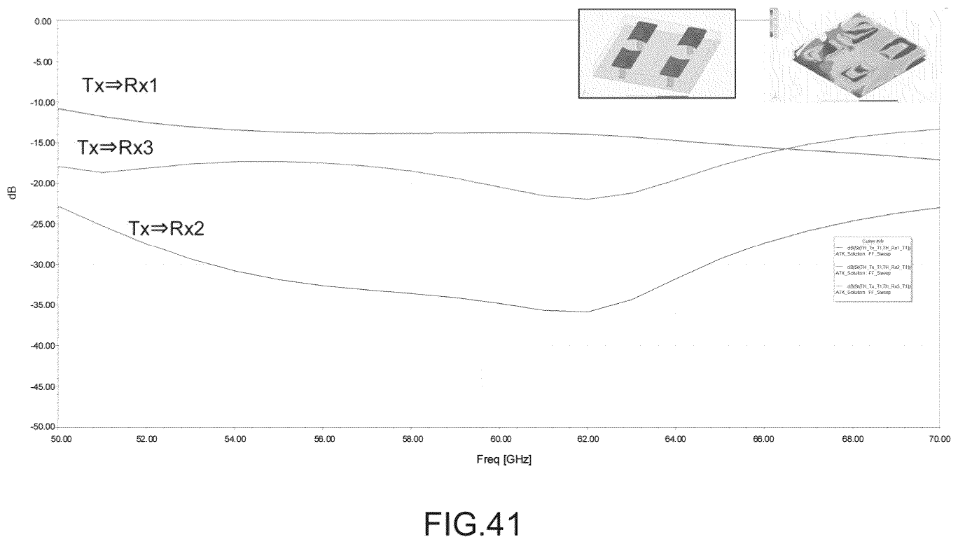

FIG. 41 is a diagram showing the isolation characteristics of the antenna module 300 shown in FIG. 40. In FIG. 41, the horizontal axis shows the frequency [GHz] of radio waves used in the antenna element 100, and the vertical axis shows the isolation characteristics [dB]. Note that a lower value [dB] in the vertical axis means higher isolation characteristics.

In addition, in FIG. 41, three graphs respectively show the isolation characteristics of the reception antenna Rx1 with respect to the transmission antenna Tx (Tx→Rx1), the isolation characteristics of the reception antenna Rx2 with respect to the transmission antenna Tx (Tx→Rx2), and the isolation characteristics of the reception antenna Rx3 with respect to the transmission antenna Tx (Tx→Rx3).

In addition, FIG. 41 shows, on its upper right, a map (thermography form) for visualizing the effect of the transmission antenna Tx on the reception antennas Rx1, Rx2, and Rx3.

As described above in the second embodiment, in the form shown in FIG. 40, the notches 210 are provided to the first conductor layers 21, and thus the isolation characteristics are improved as compared to the form without notches 210.

On the other hand, further improvement in isolation characteristics is expected. In this regard, the isolation characteristics are further improved in the fourth embodiment.

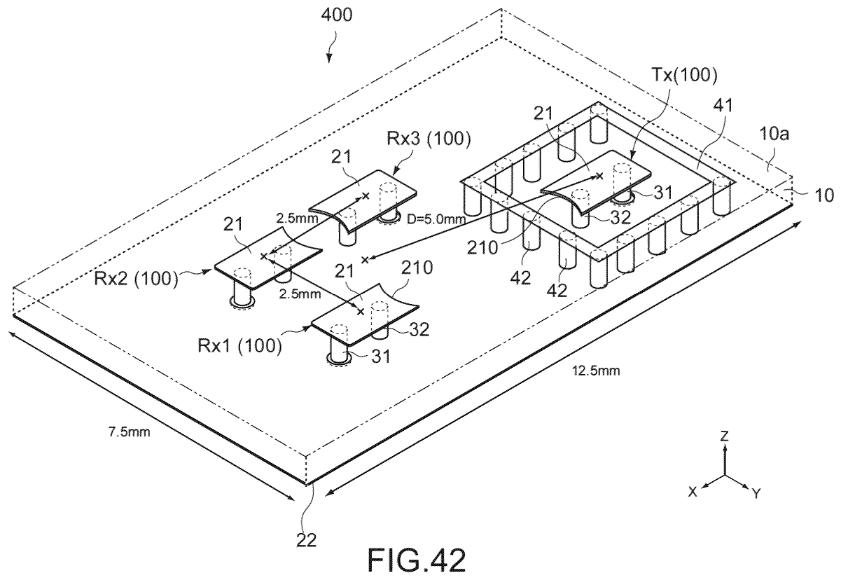

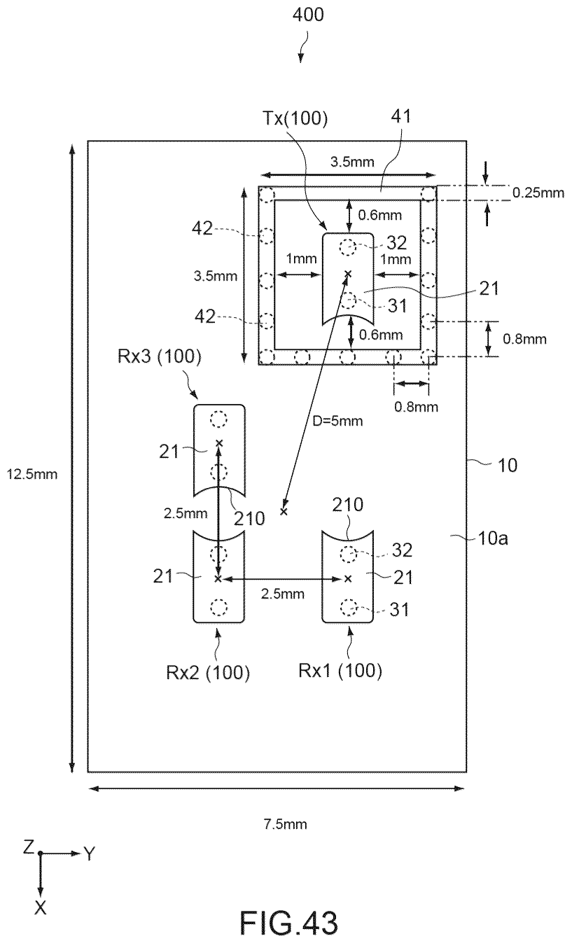

FIG. 42 is a transparent perspective view of an antenna module 400 according to the fourth embodiment. FIG. 43 is a plan view of the antenna module 400 according to the fourth embodiment. In the description of the fourth embodiment, portions different from those in the second embodiment described above (and FIGS. 40 and 41) will be mainly described.

Typically, in the fourth embodiment, three techniques according to (A) through (C) below are mainly used to improve the isolation characteristics of the reception antennas Rx1, Rx2, and Rx3 with respect to the transmission antenna Tx.
(A) Provide the notches 210 to the respective first conductor layers 21 (similar to the second embodiment described above).
(B) Increase the distance between the transmission antenna Tx and the reception antennas Rx1, Rx2, and Rx3 in the plane direction (XY-direction).
(C) Provide a shielding layer 41 for blocking an electric field from the transmission antenna Tx to the reception antennas Rx1, Rx2, and Rx3. (c) Provide third interlayer connection portions 42 that connect the shielding layer 41 and the second conductor layer 22 such that the shielding layer 41 has a ground potential.

As shown in FIGS. 42 and 43, the antenna module 400 (antenna array) includes a plurality of antenna elements 100, and the plurality of antenna elements 100 includes one transmission antenna Tx and three reception antennas Rx1, Rx2, and Rx3. The first conductor layers 21 of the transmission antenna Tx and the reception antennas Rx1, Rx2, and Rx respectively include notches 210 in the short sides facing each other in the X-axis direction.

The antenna module 400 has a rectangular shape in the plane direction, which is long in the X-axis direction. In this example, the length in the X-axis direction (direction parallel to the long side of the first conductor layer 21) is set to 12.5 mm, and the width in the Y-axis direction (direction parallel to the short side of the first conductor layer 21) is set to 7.5 mm (in FIG. 40, 5 mm×5 mm). Note that specific numerical values described in the fourth embodiment are merely examples and can be changed as appropriate.

In addition, in the Y-axis direction, a distance between the central position of the reception antenna Rx1 and the central position of the reception antenna Rx2 and a distance between the central position of the reception antenna Rx1 and the central position of the reception antenna Rx3 are each set to 2.5 mm. In addition, in the X-axis direction, a distance between the central position of the reception antenna Rx2 and the central position of the reception antenna Rx3 and a distance between the central position of the reception antenna Rx1 and the central position of the reception antenna Rx3 are each set to 2.5 mm.

In addition, in the XY-direction (plane direction), a distance D between the central position of the transmission antenna Tx and the central position of the three reception antennas Rx1, Rx3, and Rx3 is set to 5 mm. Note that the central position of the three reception antennas Rx1, Rx3, and Rx3 in the plane direction is located at the midpoint between the central position of the reception antenna Rx1 and the central position of the reception antenna Rx2 in the Y-axis direction, and also at the midpoint between the central position of the reception antenna Rx2 and the central position of the reception antenna Rx3 in the X-axis direction.

Here, the relative positional relationship of the three reception antennas Rx1, Rx2, and Rx3 is the same as that of the example shown in FIG. 40 (and the second embodiment). On the other hand, the distance D between the central position of the transmission antenna Tx and the central position of the three reception antennas Rx1, Rx3, and Rx3 is 2 mm in the example shown in FIG. 40, whereas the distance D in this example is 5 mm, which is longer than that in the example shown in FIG. 40.

Comparing the fourth embodiment with the example shown in FIG. 40 (and the second embodiment), the three reception antennas Rx1, Rx2, and R3 are moved in a direction away from the transmission antenna Tx in the X-axis direction while the relative positional relationship of the three reception antennas Rx1, Rx2, and R3 is fixed. Note that the relative positional relationship of the three reception antennas Rx1, Rx2, and R3 is fixed because it is roughly determined in relation to the use of MIMO in the present technology.

In such a manner, the central position of the three reception antennas Rx1, Rx3, and Rx3 is moved away from the central position of the transmission antenna Tx, so that the isolation characteristics of the reception antennas Rx1, Rx3, and Rx3 with respect to the transmission antenna Tx can be improved.

Typically, the distance D between the central position of the transmission antenna Tx and the central position of the three reception antennas Rx1, Rx3, and Rx3 in the XY-direction (plane direction) is set to be equal to or longer than half a wavelength (½ λ) of the radio waves used. Note that the experimental results have shown that setting the distance D to be equal to or longer than half a wavelength (½ λ) improves the isolation characteristics of the reception antennas Rx1, Rx3, and Rx3 with respect to the transmission antenna Tx.

On the other hand, it seems that as the distance D becomes larger, the isolation characteristics of the reception antennas Rx1, Rx3, and Rx3 with respect to the transmission antenna Tx are improved, but the experimental results have shown that the improvement tends to pass a peak when the distance D is equal to or larger than a certain distance. In addition, of course, there is also a problem that as the distance D becomes larger, the antenna module 400 is more increased in size. If the antenna module 400 is increased in size, a transmission loss occurs between the millimeter wave radar IC 301, and the reception antenna Tx and reception antennas Rx1, Rx2, and Rx2, leading to a problem that the entire performance of the system is deteriorated.

Hence, typically, the distance D in the XY-direction (plane direction) between the central position of the transmission antenna Tx and the central position of the three reception antennas Rx1, Rx3, and Rx3 is set to be equal to or less than 1.5 times (1.5 λ)) the wavelength of the radio waves used. This makes it possible to suitably improve the isolation characteristics without increasing the size of the antenna module 400.

In addition, the antenna module 400 (antenna array) includes the shielding layer 41 provided, on the surface 10a of the dielectric layer 10, between the first conductor layer 21 of the transmission antenna Tx and the first conductor layers 21 of the reception antennas Rx1, Rx2, and Rx3. The shielding layer 41 can block unwanted electric fields (radio waves) that get in directly from the transmission antenna Tx to the reception antennas Rx1, Rx2, and Rx3.

The shielding layer 41 is formed in an annular (and strap-like) shape on the surface 10a of the dielectric layer 10 so as to surround the first conductor layer 21 of the transmission antenna Tx. In the example here, the shielding layer 41 has a rectangular annular shape, but this shape may be any other shape, such as an oval annular shape.

The shielding layer 41 is typically a metal layer formed on the surface 10a of the dielectric layer 10. The metal material used for the shielding layer 41 is, for example, copper or aluminum, but the material is not particularly limited. In addition, for such a material, the same material as that of the first conductor layer 21 and the second conductor layer may be used, or a different material may be used. The thickness of the shielding layer 41 is not particularly limited, and may be the same as or different from the thickness of the first conductor layer 21 and the second conductor layer 22.

In the example here, the length of the outer circumference of the shielding layer 41 is set to 3.5 mm×3.5 mm (X-axis×Y-axis), and the width of the shielding layer 41 (the width of the strap) is set to 0.25 mm. In addition, in the Y-axis direction, a distance between the inner circumference of the shielding layer 41 and the long side of the first conductor layer 21 of the transmission antenna Tx is set to 1 mm. In addition, in the X-axis direction, the distance between the inner circumference of the shielding layer 41 and the short side of the first conductor layer 21 of the transmission antenna Tx is set to 0.6 mm.

In addition, the antenna module 400 (antenna array) includes the plurality of third interlayer connection portions 42. The third interlayer connection portion 42 penetrates the dielectric layer 10 in its thickness direction (Z-axis direction) and electrically connects the shielding layer 41 and the second conductor layer 22. The third interlayer connection portion 42 is a cylindrical conductor similar to the first interlayer connection portion 31 and the second interlayer connection portion 32, and is formed of a through-hole plating or an embedded via filled with a conductive material, which is provided in the dielectric layer 10.

The third interlayer connection portion 42 is connected to be perpendicular to the shielding layer 41 and the second conductor layer 22, and thus the length (height) of the third interlayer connection portion 42 corresponds to the thickness of the dielectric layer 10 (0.65 mm). The diameter of the third interlayer connection portion 42 is, for example, the same as the width of the shielding layer 41 (the width of the strap). The diameter of the third interlayer connection portion 42 may be the same as or different from the first interlayer connection portion 31 and the second interlayer connection portion 32.

The plurality of third interlayer connection portions 42 is disposed at predetermined intervals (0.8 mm) along the circumferential direction of the shielding layer 41. Note that in the example here, the plurality of third interlayer connection portions 42 is not provided over the entire circumference of the shielding layer 41, but provided to a part of the entire circumference of the shielding layer 41. Specifically, the plurality of third interlayer connection portions 42 is provided at locations corresponding to one side along the Y-axis direction (one side between the transmission antenna Tx and the reception antenna Rx) and two sides along the X-axis direction, out of the four sides of the rectangle of the shielding layer 41. Note that the plurality of third interlayer connection portions 42 may be provided over the entire circumference of the shielding layer 41.

Here, the shielding layer 41 is connected to the second conductor layer 22 via the plurality of third interlayer connection portions 42. The second conductor layer 22 is grounded, and the shielding layer 41 is also grounded accordingly. Thus, setting the shielding layer 41 to have a ground potential makes it possible to suitably block the electric fields (radio waves) from the transmission antenna Tx to the reception antennas Rx1, Rx2, and Rx3.

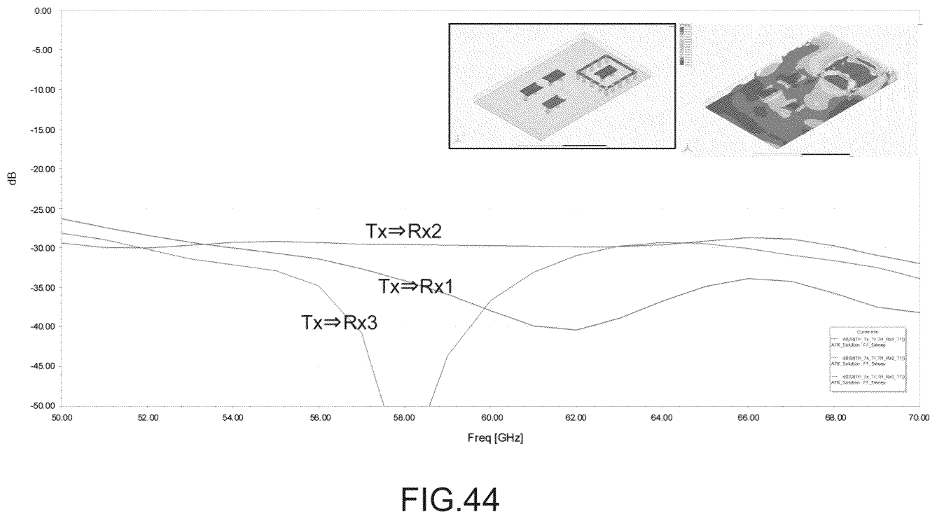

FIG. 44 is a diagram showing the isolation characteristics of the antenna module 400. In FIG. 44, the horizontal axis shows the frequency [GHz] of radio waves used in the antenna element 100, and the vertical axis shows the isolation characteristics [dB]. Note that a lower value [dB] in the vertical axis means higher isolation characteristics.

In addition, in FIG. 44, three graphs respectively show the isolation characteristics of the reception antenna Rx1 with respect to the transmission antenna Tx (Tx→Rx1), the isolation characteristics of the reception antenna Rx2 with respect to the transmission antenna Tx (Tx→Rx2), and the isolation characteristics of the reception antenna Rx3 with respect to the transmission antenna Tx (Tx→Rx3).

In addition, FIG. 44 shows, on its upper right, a map (thermography form) for visualizing the effect of the transmission antenna Tx on the reception antennas Rx1, Rx2, and Rx3.

Comparing FIG. 44 (fourth embodiment) and FIG. 41 (second embodiment), the graph of Tx→Rx1, the graph of Tx→Rx2, and the graph of Tx→Rx3 tend to decrease downwardly as a whole. This means that the fourth embodiment, which is a combination of (A) “notch 210”, (B) “distance D”, and (C) “shielding layer 42” described above, provides the isolation characteristics improved more than the second embodiment including only (A) “notch” described above.

In addition, in the three graphs of FIG. 44, the values indicating the isolation characteristics are substantially 30 [dB] or less. In such a manner, setting the value indicating the isolation characteristics to be 30 [dB] or less makes it possible to provide sufficient isolation characteristics.

### Action etc.

As described above, in the fourth embodiment, the shielding layer 41 (metal layer) that blocks the electric fields from the transmission antenna Tx to the reception antennas Rx1, Rx2, and Rx3 is provided, on the surface 10a of the dielectric layer 10, between the first conductor layer 21 of the transmission antenna Tx and the first conductor layers 21 of the reception antennas Rx1, Rx2, and Rx3. This makes it possible to further improve the isolation characteristics of the reception antennas Rx1, Rx2, and Rx3 with respect to the transmission antenna Tx.

In addition, in the fourth embodiment, the shielding layer 41 is formed in an annular shape on the surface 10a of the dielectric layer 10 so as to surround the first conductor layer 21 of the transmission antenna Tx. This makes it possible to further improve the isolation characteristics of the reception antennas Rx1, Rx2, and Rx3 with respect to the transmission antenna Tx.

In addition, in the fourth embodiment, the third interlayer connection portion 42 that penetrates the dielectric layer 10 and electrically connects the shielding layer 41 and the second conductor layer 22 is provided. This makes it possible to set the shielding layer 41 to a ground potential and possible to suitably block the electric fields (radio waves) from the transmission antenna Tx to the reception antennas Rx1, Rx2, and Rx3.

In addition, in the fourth embodiment, the third interlayer connection portion 42 is a through-hole plating or an embedded via that is provided in the dielectric layer 10. This makes it possible to suitably connect the shielding layer 41 and the second conductor layer 22.

In addition, in the fourth embodiment, when the wavelength of the radio waves used is denoted by x and the distance in the planar direction between the central position of the transmission antenna Tx and the central position of the previous reception antennas Rx1, Rx2, and Rx3 is denoted by D, 0.5 λ≤D≤1.5 λ. Setting the distance D to be equal to or longer than half a wavelength (½ λ) makes it possible to further improve the isolation characteristics of the reception antennas Rx1, Rx3, and Rx3 with respect to the transmission antenna Tx. In addition, setting the distance D to be equal to or less than 1.5 times (1.5 λ) the wavelength of the radio waves used makes it possible to suitably improve the isolation characteristics without increasing the size of the antenna module 400.

### Various Modified Examples in Fourth Embodiment

Next, various modified examples in the fourth embodiment will be described.

In the fourth embodiment described above, the case in which a combination of three of (A) “notch 210”, (B) “distance D”, and (C) “shielding layer 42” is used has been described. On the other hand, any of the following combinations of (A) “notch 210”, (B) “distance D”, and (C) “shielding layer 42” may be used.
1. Form of only (A) “notch 210” (second embodiment)
2. Form of only (B) “distance D”
3. Form of only (C) “shielding layer 42”
4. Combination form of (A) “notch 210” and (B) “distance D”
5. Combination form of (A) “notch 210” and (C) “shielding layer 42”
6. Combination form of (B) “distance D” and (C) “shielding layer 42”
7. Combination form of (A) “notch 210”, (B) “distance D”, and (C) “shielding layer 42” (fourth embodiment)

Here, in the form including (C) “shielding layer 42”, that is, in the four forms of 3., 5., 6., and 7., (c) “third interlayer connection portion 42” may be provided, whereas (c) “third interlayer connection portion 42” may also be omitted. Therefore, the four forms of 3., 5., 6., and 7. are branched into two depending on the presence/absence of (c) “third interlayer connection portion 42”, but any of those forms may be used. Note that the above fourth embodiment describes the form including the combination of three members, 7. (A) “notch 210”, (B), and (C), and also including (c), as a representative example.

Here, 4. combination form of (A) “notch 210” and (B) “distance D” will be described as an example in a representative manner.

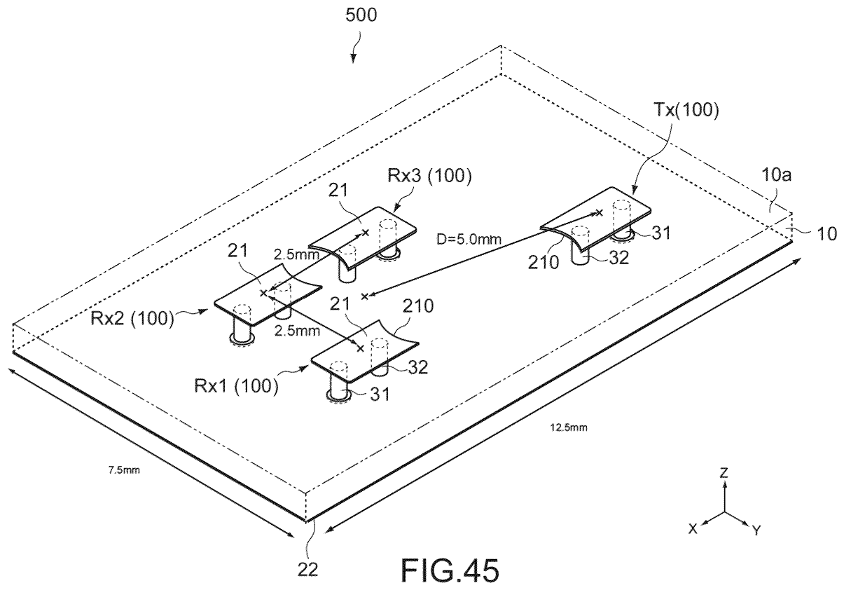

FIG. 45 is a transparent perspective view of an antenna module 500 according to a modified example of the fourth embodiment. In the antenna module 500 shown in FIG. 45, the shielding portion 41 and the third interlayer connection portion 42 are omitted, as compared to the antenna module 400 shown in FIG. 42. Other portions are the same as those in FIG. 42.

Note that in the antenna module 500, the first conductor layers 21 of the transmission antenna Tx and the reception antennas Rx1, Rx2, and Rx respectively include notches 210 in the short sides facing each other in the X-axis direction. In addition, in the XY-direction (plane direction), the distance D between the central position of the transmission antenna Tx and the central position of the three reception antennas Rx1, Rx3, and Rx3 is set to 5 mm. In other words, the distance D satisfies the condition that 0.5 λ≤D≤1.5 λ.

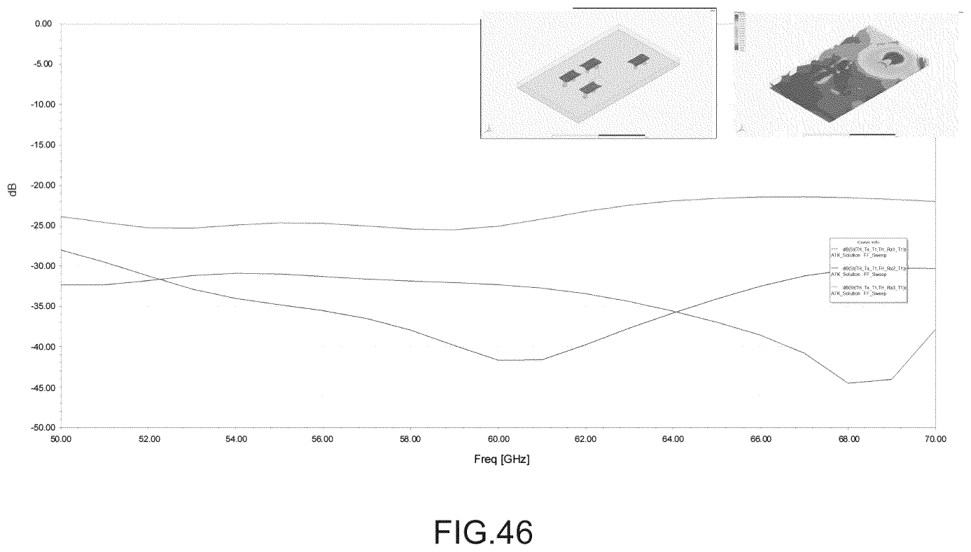

FIG. 46 is a diagram showing the isolation characteristics of the antenna module 500. In FIG. 46, the horizontal axis shows the frequency [GHz] of radio waves used in the antenna element 100, and the vertical axis shows the isolation characteristics [dB]. Note that a lower value [dB] in the vertical axis means higher isolation characteristics.

In addition, in FIG. 46, three graphs respectively show the isolation characteristics of the reception antenna Rx1 with respect to the transmission antenna Tx (Tx→Rx1), the isolation characteristics of the reception antenna Rx2 with respect to the transmission antenna Tx (Tx→Rx2), and the isolation characteristics of the reception antenna Rx3 with respect to the transmission antenna Tx (Tx→Rx3).

In addition, FIG. 46 shows, on its upper right, a map (thermography form) for visualizing the effect of the transmission antenna Tx on the reception antennas Rx1, Rx2, and Rx3.

Comparing FIG. 46 (modified example of the fourth embodiment) and FIG. 41 (second embodiment), the graph of Tx→Rx1, the graph of Tx→Rx2, and the graph of Tx→Rx3 tend to decrease downwardly as a whole. This means that the modified example of the fourth embodiment, which is a combination of (A) “notch 210” and (B) “distance D” described above, provides the isolation characteristics improved more than the second embodiment including only (A) “notch” described above.

In the above description, the form in which the shielding layer 41 entirely surrounds the first conductor layer 21 of the transmission antenna Tx has been described. On the other hand, the shielding layer 41 may be formed to partially surround the first conductor layer 21 of the transmission antenna Tx. Typically, the shielding layer 41 only needs to be formed to be interposed between the first conductor layer 21 of the transmission antenna Tx and the first conductor layers 21 of the reception antennas Rx1, Rx2, and Rx3.

In addition, in the above description, the case where the shielding layer 41 surrounds the side of the transmission antenna Tx, but the shielding layer 42 may be formed to surround the reception antennas Rx1, Rx2, and Rx3 (partially or entirely). In this case, the shielding layer 41 may be formed to entirely surround the three reception antennas Rx1, Rx2, and Rx3 together, or formed to individually surround the three reception antennas Rx1, Rx2, and Rx3.

Note that if the shielding layer 41 is provided on the side of the reception antennas Rx1, Rx2, and Rx3, typically, the shielding layer 41 is provided with the third interlayer connection portions 42 and set to a ground potential.

Here, if the shielding layer 41 is provided on the side of the reception antennas Rx1, Rx2, and Rx3 and if the shielding layer 41 is not set to a ground potential, experimental results show that the shielding layer 41 adversely affects the isolation characteristics. This is because when the shielding layer 41 that is not grounded is provided near the reception antennas Rx1, Rx2, and Rx3, this shielding layer 41 serves as a bridge for the electric fields (radio waves) from the transmission antenna Tx to the reception antennas Rx1, Rx2, and Rx3. Therefore, if the shielding layer 41 is provided on the side of the reception antennas Rx1, Rx2, and Rx3, typically, the shielding layer 41 is provided with the third interlayer connection portion 42 and is set to a ground potential.

Note that the present technology can also have the following configurations.
(1) An antenna element, including:
   a first conductor layer having a planar element shape;
   a second conductor layer connected to a ground potential;
   a dielectric layer provided between the first conductor layer and the second conductor layer;
   a first interlayer connection portion that penetrates the dielectric layer and connects the first conductor layer to a power feed portion; and
   a second interlayer connection portion that penetrates the dielectric layer and connects the first conductor layer and the second conductor layer.
(2) The antenna element according to (1), in which
   the first conductor layer is formed to have a smaller area than an area of the second conductor layer.
(3) The antenna element according to (2), in which
   a loop length formed by the first interlayer connection portion, the first conductor layer, and the second interlayer connection portion is equal to or smaller than one wavelength of a radio wave used.
(4) The antenna element according to (3), in which
   the loop length is a size corresponding to half a wavelength of the radio wave used.
(5) The antenna element according to any one of (2) to (4), in which
   the planar shape of the first conductor layer is a rectangular shape having a long side and a short side.
(6) The antenna element according to (5), in which
   the first conductor layer includes a first region to which the first interlayer connection portion is connected to, and a second region to which the second interlayer connection portion is connected to, and
   the first region and the second region are disposed away from a circumferential portion of the first conductor layer.
(7) The antenna element according to (6), in which
   the first region and the second region are disposed in a direction parallel to the long side.
(8) The antenna element according to (6) or (7), in which
   the first region and the second region are disposed in a direction intersecting with a direction parallel to the long side.
(9) The antenna element according to any one of (1) to (8), in which
   the dielectric layer is a dielectric substrate made of a dielectric material,
   the first conductor layer is a metal layer formed on a first main surface of the dielectric substrate, and
   the second conductor layer is a metal layer formed on a second main surface of the dielectric substrate on a side opposite to the first main surface.
(10) The antenna element according to any one of (1) to (9), in which
   the second conductor layer has an opening formed with an opening diameter larger than an outer diameter of the first interlayer connection portion.
(11) The antenna element according to any one of (1) to (10), in which
   the first interlayer connection portion and the second interlayer connection portion are each a through-hole plating or an embedded via that is provided to the dielectric layer.
(12) An antenna array, including
   a plurality of antenna elements each including
      a first conductor layer having a planar element shape,
      a second conductor layer connected to a ground potential,
      a dielectric layer provided between the first conductor layer and the second conductor layer,
      a first interlayer connection portion that penetrates the dielectric layer and connects the first conductor layer to a power feed portion, and
      a second interlayer connection portion that penetrates the dielectric layer and connects the first conductor layer and the second conductor layer, in which
   the first conductor layer of each of the plurality of antenna elements is arrayed on one surface of the dielectric layer.
(13) The antenna array according to (12), in which
   at least one of the plurality of antenna elements is a transmission antenna element, and at least another one of the plurality of antenna elements is a reception antenna element.
(14) The antenna array according to (13), in which
   the plurality of antenna elements is arrayed in a matrix along a first axial direction and a second axial direction orthogonal to each other on the surface.
(15) The antenna array according to (14), in which
   the first conductor layer has a rectangular planar shape having a long side parallel to the first axial direction and a short side parallel to the second axial direction, and
   the short sides facing each other of two of the first conductor layers arrayed in the first axial direction each have a notch that partially widens an interval between the two first conductor layers.
(16) The antenna array according to any one of (12) to (15), in which
   the second conductor layer of each of the plurality of antenna elements is formed of a common conductor layer.
(17) The antenna array according to any one of (13) to (16), further including
   a shielding layer that is provided, on the surface of the dielectric layer, between the first conductor layer of the transmission antenna element and the first conductor layer of the reception antenna element, and blocks an electric field from the transmission antenna element to the reception antenna.
(18) The antenna array according to (17), in which
   the shielding layer is formed in an annular shape on the surface of the dielectric layer to surround the first conductor layer of the transmission antenna element.
(19) The antenna array according to (17) or (18), further including
   a third interlayer connection portion that penetrates the dielectric layer and connects the shielding layer and the second conductor layer.
(20) The antenna array according to (19), in which
   the third interlayer connection portion is a through-hole plating or an embedded via that is provided to the dielectric layer.
(21) The antenna array according to any one of (17) to (20), in which
   the shielding layer is a metal layer formed on the surface of the dielectric layer.
(22) The antenna array according to any one of (13) to (21), in which
   the plurality of antenna elements includes one transmission antenna element and a plurality of reception antenna elements, and
   when a wavelength of a radio wave used is denoted by λ, and a distance in a plane direction between a central position of the one transmission antenna element and a central position of the plurality of reception antenna elements is denoted by D, 0.5 λ≤D.
(23) The antenna array according to (22), in which
   D≤1.5 λ.
(24) An antenna module, including:
   a plurality of antenna elements each including
      a first conductor layer having a planar element shape,
      a second conductor layer connected to a ground potential,
      a dielectric layer provided between the first conductor layer and the second conductor layer,
      a first interlayer connection portion that penetrates the dielectric layer and connects the first conductor layer to a power feed portion, and
      a second interlayer connection portion that penetrates the dielectric layer and connects the first conductor layer and the second conductor layer; and
   a signal processing circuit connected to the plurality of antenna elements.

### REFERENCE SIGNS LIST

10 dielectric layer
10a first main surface
10b second main surface
21 first conductor layer
22 second conductor layer
22a opening
31 first interlayer connection portion
32 second interlayer connection portion
41 shielding layer
42 third interlayer connection portion
100, 151 to 156 antenna element
200 antenna array
210 notch
300, 400, 500 antenna module
301 signal processing circuit

1. An antenna element, comprising:
a first conductor layer having a planar element shape;
a second conductor layer connected to a ground potential;
a dielectric layer provided between the first conductor layer and the second conductor layer;
a first interlayer connection portion that penetrates the dielectric layer and connects the first conductor layer to a power feed portion; and
a second interlayer connection portion that penetrates the dielectric layer and connects the first conductor layer and the second conductor layer.

2. The antenna element according to claim 1, wherein
the first conductor layer is formed to have a smaller area than an area of the second conductor layer.

3. The antenna element according to claim 2, wherein
a loop length formed by the first interlayer connection portion, the first conductor layer, and the second interlayer connection portion is equal to or smaller than one wavelength of a radio wave used.

4. The antenna element according to claim 3, wherein
the loop length is a size corresponding to half a wavelength of the radio wave used.

5. The antenna element according to claim 2, wherein
the planar shape of the first conductor layer is a rectangular shape having a long side and a short side.

6. The antenna element according to claim 5, wherein
the first conductor layer includes a first region to which the first interlayer connection portion is connected, and a second region to which the second interlayer connection portion is connected, and
the first region and the second region are disposed away from a circumferential portion of the first conductor layer.

7. The antenna element according to claim 6, wherein
the first region and the second region are disposed in a direction parallel to the long side.

8. The antenna element according to claim 6, wherein
the first region and the second region are disposed in a direction intersecting with a direction parallel to the long side.

9. The antenna element according to claim 1, wherein
the dielectric layer is a dielectric substrate made of a dielectric material,
the first conductor layer is a metal layer formed on a first main surface of the dielectric substrate, and
the second conductor layer is a metal layer formed on a second main surface of the dielectric substrate on a side opposite to the first main surface.

10. The antenna element according to claim 1, wherein
the second conductor layer has an opening formed with an opening diameter larger than an outer diameter of the first interlayer connection portion.

11. The antenna element according to claim 1, wherein
the first interlayer connection portion and the second interlayer connection portion are each a through-hole plating or an embedded via that is provided to the dielectric layer.

12. An antenna array, comprising
a plurality of antenna elements each including
a first conductor layer having a planar element shape,
a second conductor layer connected to a ground potential,
a dielectric layer provided between the first conductor layer and the second conductor layer,
a first interlayer connection portion that penetrates the dielectric layer and connects the first conductor layer to a power feed portion, and
a second interlayer connection portion that penetrates the dielectric layer and connects the first conductor layer and the second conductor layer, wherein
the first conductor layer of each of the plurality of antenna elements is arrayed on one surface of the dielectric layer.

13. The antenna array according to claim 12, wherein
at least one of the plurality of antenna elements is a transmission antenna element, and at least another one of the plurality of antenna elements is a reception antenna element.

14. The antenna array according to claim 13, wherein
the plurality of antenna elements is arrayed in a matrix along a first axial direction and a second axial direction orthogonal to each other on the surface.

15. The antenna array according to claim 14, wherein
the first conductor layer has a rectangular planar shape having a long side parallel to the first axial direction and a short side parallel to the second axial direction, and
the short sides facing each other of two of the first conductor layers arrayed in the first axial direction each have a notch that partially widens an interval between the two first conductor layers.

16. The antenna array according to claim 12, wherein
the second conductor layer of each of the plurality of antenna elements is formed of a common conductor layer.

17. The antenna array according to claim 13, further comprising
a shielding layer that is provided, on the surface of the dielectric layer, between the first conductor layer of the transmission antenna element and the first conductor layer of the reception antenna element, and blocks an electric field from the transmission antenna element to the reception antenna.

18. The antenna array according to claim 17, wherein
the shielding layer is formed in an annular shape on the surface of the dielectric layer to surround the first conductor layer of the transmission antenna element.

19. The antenna array according to claim 17, further comprising
a third interlayer connection portion that penetrates the dielectric layer and connects the shielding layer and the second conductor layer.

20. The antenna array according to claim 19, wherein
the third interlayer connection portion is a through-hole plating or an embedded via that is provided to the dielectric layer.

21. The antenna array according to claim 17, wherein
the shielding layer is a metal layer formed on the surface of the dielectric layer.

22. The antenna array according to claim 13, wherein
the plurality of antenna elements includes one transmission antenna element and a plurality of reception antenna elements, and
when a wavelength of a radio wave used is denoted by λ, and a distance in a plane direction between a central position of the one transmission antenna element and a central position of the plurality of reception antenna elements is denoted by D, 0.5 λ≤D.

23. The antenna array according to claim 22, wherein
D≤1.5 λ.

24. An antenna module, comprising:
a plurality of antenna elements each including
a first conductor layer having a planar element shape,
a second conductor layer connected to a ground potential,
a dielectric layer provided between the first conductor layer and the second conductor layer,
a first interlayer connection portion that penetrates the dielectric layer and connects the first conductor layer to a power feed portion, and
a second interlayer connection portion that penetrates the dielectric layer and connects the first conductor layer and the second conductor layer; and
a signal processing circuit connected to the plurality of antenna elements.
